(19) United States
(12) Patent Application Publication
(10) Pub. No.: US 2026/0030015 A1
(43) Pub. Date: Jan. 29, 2026

(54) Firmware Upgrade Method and Device, Server, Terminal Device and Storage Medium

(71) Applicant: BOE Technology Group Co., Ltd., Beijing (CN)

(72) Inventors: Rongzuo Zhang, Beijing (CN); Kai Zhao, Beijing (CN); Hongtao Guan, Beijing (CN); Tao Li, Beijing (CN)

(73) Assignee: BOE Technology Group Co., Ltd., Beijing (CN)

(21) Appl. No.: 18/996,967

(22) PCT Filed: Mar. 31, 2023
(86) PCT No.: PCT/CN2023/085613

§ 371 Date: Jan. 17, 2025

(30) Foreign Application Priority Data
Oct. 21, 2022 (CN) 202211295975.2

(51) Int. Cl. G06F 8/65; G06F 21/57

(52) U.S. Cl. CPC G06F 8/65; G06F 21/572; G06F 2221/033

(57) ABSTRACT

A firmware upgrade method and device, a server, a terminal device, and a storage medium. The firmware upgrade method includes: acquiring a target firmware upgrade package; receiving an identification code of a target terminal device; splitting the target firmware upgrade package into sub-upgrade packages on the basis of the identification code of the target terminal device; and storing the sub-upgrade packages and/or sending the sub-upgrade packages to the target terminal device.

This application claims the priority of Chinese Patent Application No.202211295975.2 filed on Oct. 21, 2022, and the disclosure of the above-mentioned Chinese Patent Application is hereby incorporated in its entirety as a part of this application.

### TECHNICAL FIELD

The invention relates to the technical field of firmware upgrade, in particular to a firmware upgrade method, device, server, terminal device and storage medium.

### BACKGROUND

Different from the traditional network security, Internet of Things (IOT) security is the product of the integration of network security and other engineering disciplines. Compared with simple data, server, network infrastructure and information security, the connotation of Internet of Things security is richer. Moreover, the security of the Internet of Things also needs to include direct or distributed monitoring and control of the state of the networked physical system.

There are a large number of terminal devices in the Internet of Things system, and a large part of them are single-chip devices with limited computing power and storage resources. In this equipment environment with severely limited resources, the traditional security management solutions based on operating system, such as firewall and application store, cannot guarantee the security of the equipment during the upgrade.

Therefore, a safe firmware upgrade solution is urgently needed in this field to effectively avoid the security risks in the firmware upgrade process of terminal device.

### SUMMARY

The invention provides a firmware upgrading method, device, server, terminal device and storage medium, which can effectively avoid security risks in the firmware upgrading process.

According to an embodiment of this disclosure, a firmware upgrade method applied to a server is provided, comprising: obtaining a target firmware upgrade packet; receiving an identification code of a target terminal device; splitting the target firmware upgrade packet into sub-upgrade packets based on the identification code of the target terminal device; storing the sub-upgrade packets and/or transmitting the sub-upgrade packets to the target terminal device.

The firmware upgrade method according to the embodiment of this disclosure, wherein the method further comprises: obtaining a size of the sub-upgrade packets through the identification code of the target terminal device, determining a quantity of split sub-upgrade packets based on the size of the sub-upgrade packets.

The firmware upgrade method according to the embodiment of this disclosure, wherein the method further comprises: based on the identification code of the sub-upgrade packets and the default modifiable address, download address from which the target terminal device downloads the sub-upgrade packets is determined.

The firmware upgrade method according to the embodiment of this disclosure, wherein the method further comprises: obtaining the sequence identification of the sub-upgrade packets through the identification code of the target terminal device, based on the sequence identification of the sub-upgrade packets, determining whether to change the sequence of the sub-upgrade packets, in response to determining not to change that sequence of the sub-upgrade packets, the sub-upgrade packets are numbered according to the initial sequence of the sub-upgrade packets, in response to determining to change the sequence of the sub-upgrade packets, the sequence of the sub-upgrade packets is changed, and the sub-upgrade packets are numbered according to the changed sequence of the sub-upgrade packets.

The firmware upgrade method according to the embodiment of this disclosure, wherein each of the sub-upgrade packets comprises a sub-upgrade header, and the sub-upgrade header comprises a number of the sub-upgrade packet.

The firmware upgrade method according to the embodiment of this disclosure, wherein the header of the sub-upgrade packet further comprises at least one of an identification code of the target terminal device and a quantity of sub-upgrade packets split by the target firmware upgrade packet.

The firmware upgrade method according to the embodiment of this disclosure, wherein determining whether to change the sequence of the sub-upgrade packets based on the sequence identification of the sub-upgrade packets comprises: identifying a numerical value indicated by the sequence identification, determining whether to change the sequence of the sub-upgrade packets based on the numerical value indicated by the sequence identification.

The firmware upgrade method according to the embodiment of this disclosure, wherein determining whether to change the sequence of sub-upgrade packets based on the numerical value indicated by the sequence identification comprises: determining whether to change the sequence of the sub-upgrade packet based on whether the numerical value indicated by the sequence identification is a first predetermined numerical value.

The firmware upgrade method according to the embodiment of this disclosure, wherein determining whether to change the sequence of the sub-upgrade packets based on the numerical value indicated by the sequence identification comprises: taking a remainder of the numerical value indicated by the sequence identification over a second predetermined numerical value, wherein the second predetermined numerical value is a natural number greater than or equal to 2, based on the remainder, determining whether to change the sequence of the sub-upgrade packet.

The firmware upgrade method according to the embodiment of this disclosure, wherein the second predetermined value is 2, wherein determining whether to change the sequence of the sub-upgrade packets based on the numerical value indicated by the sequence identification comprises determining whether to change the sequence of the sub-upgrade packets based on the parity of the numerical value indicated by the sequence identification.

The firmware upgrade method according to the embodiment of this disclosure, wherein changing the sequence of the sub-upgrade packets based on the sequence identification comprises: identifying the numerical value indicated by the sequence identification, changing the sequence of the sub-upgrade packets based on the numerical value indicated by the sequence identification.

The firmware upgrade method according to the embodiment of this disclosure, wherein the sequence identification comprises data with a predetermined number of bits, and identifying the numerical value indicated by the sequence identification comprises identifying the numerical value indicated by the data, wherein, changing the sequence of the sub-upgrade packets comprises: dividing the sub-upgrade packets into sub-upgrade packet groups, each sub-upgrade packet group comprises a specific quantity of sub-upgrade packets adjacent in the initial sequence, wherein the specific quantity is the maximum numerical value that data with a predetermined number of bits can indicate plus 1, exchanging the sequence of two sub-upgrade packets in each sub-upgrade packet group whose initial sequence differs by the numerical value indicated by the data.

The firmware upgrade method according to the embodiment of this disclosure, wherein changing the sequence of the sub-upgrade packets comprises: dividing the sub-upgrade packets into sub-upgrade packet groups, each sub-upgrade packet group comprises a specific quantity of sub-upgrade packets adjacent in the initial sequence, wherein the specific quantity is determined in advance at the server, exchanging the sequence of two sub-upgrade packets in each sub-upgrade packet group whose initial sequence differs by numerical value less than the specific quantity.

The firmware upgrade method according to the embodiment of this disclosure, further comprising generating a matrix according to the quantity of sub-upgrade packets, the sub-upgrade packets are arranged in a matrix, wherein, changing the sequence of the sub-upgrade packets comprises translating the sub-upgrade packets in the matrix according to the sequence identification.

The firmware upgrade method according to the embodiment of this disclosure, wherein generating a matrix according to the quantity of the sub-upgrade packets comprises determining whether to generate an odd dimensional matrix or an even dimensional matrix according to the quantity of the sub-upgrade packets.

The firmware upgrade method according to the embodiment of this disclosure, wherein the method further comprises filling the matrix with one or more of garbled packets, empty packets and repeated sub-upgrade packets.

The firmware upgrade method according to the embodiment of this disclosure, wherein the sequence identification indicates one or more of the number of translation of the sub-upgrade packets in the matrix, the moving out direction of the sub-upgrade packet, and the clockwise and counterclockwise rotation of the sub-upgrade packet in the matrix.

The firmware upgrade method according to the embodiment of this disclosure, further comprising determining the way of translation of the sub-upgrade packets according to the serial number of the sub-upgrade packet in the matrix and the dimension of the matrix.

The firmware upgrade method according to the embodiment of this disclosure, further comprising storing the header of the target firmware upgrade packet and/or transmitting the header of the target firmware upgrade packet to the target terminal device, the header of the target firmware upgrade packet includes one or more of the identification code of the target terminal device, quantity and number of the sub-upgrade packets, a firmware upgrade key and/or a integrity verification information.

According to an embodiment of this disclosure, a firmware upgrade method applied to a terminal device is provided, comprising: obtaining a firmware upgrade instruction; transmitting an identification code of the target terminal device; download sub-upgrade packets from the server; based on the identification code of the target terminal device, splicing the sub-upgrade packet into a target firmware upgrade packet.

The firmware upgrade method according to the embodiment of this disclosure, wherein the method further comprises downloading a header of the firmware upgrade packet from the server, and performing follows by security boot program: in response to downloading all sub-upgrade packets and the firmware upgrade header to the terminal device, determining whether to change the sequence of downloaded sub-upgrade packets based on the sequence identification in the identification code of the terminal device; performing a security or integrity verification on the downloaded sub-upgrade packets; in response to the downloaded sub-upgrade packet passing the security or integrity verification, running the target firmware spliced by the sub-upgrade packets.

The firmware upgrade method according to the embodiment of this disclosure, wherein obtaining the firmware upgrade instruction comprises obtaining the firmware upgrade instruction and the security verification key off the WAN; wherein, downloading sub-upgrade packets from the server comprise obtaining the firmware upgrade packet and a security key of the firmware upgrade packet via WWN; performing the security verification on the downloaded sub-upgrade packets includes determining whether the security verification key matches the security key of the firmware upgrade packet.

According to an embodiment of this disclosure, a firmware upgrading device applied to a server is provided, comprising: firmware upgrade packet obtaining apparatus for obtaining a target firmware upgrade packet; reception apparatus for receiving an identification code of a target terminal device; splitting apparatus for splitting the target firmware upgrade packet into sub-upgrade packets based on the identification code of the target terminal device; storage/transmission apparatus for storing the sub-upgrade packets and/or transmitting the sub-upgrade packets to the target terminal device.

According to an embodiment of this disclosure, a firmware upgrading device applied to a terminal device is provided, comprising: a firmware upgrade instruction obtaining apparatus for obtaining a firmware upgrade instruction; reception apparatus for transmitting the identification code of the target terminal device; download/reception apparatus for downloading/receiving the sub-upgrade packet from the server; splicing apparatus for splicing the sub-upgrade packets into a target firmware upgrade packet based on the identification code of the target terminal device.

According to an embodiment of this disclosure, a server comprising a memory and one or more processors, wherein a computer program is stored on the memory, and when the computer program is executed by the one or more processors, the method above is implemented.

According to an embodiment of this disclosure, a terminal device, comprising a memory and one or more processors, wherein a computer program is stored on the memory, and when the computer program is executed by the one or more processors, the method above is implemented.

According to an embodiment of this disclosure, a method for secure booting for a terminal device, comprising: in response to all sub-upgrade packets and firmware upgrade headers being downloaded to the terminal device, determining whether to change the sequence of downloaded sub-upgrade packets based on the sequence identification in the identification code of the terminal device; performing a security or integrity verification on the downloaded sub-upgrade packets; in response to the downloaded sub-upgrade packet passing the security or integrity verification, running the target firmware spliced by the sub-upgrade packets.

According to an embodiment of this disclosure, a security verification method for a target terminal device is provided, comprising: obtaining a firmware upgrade instruction and a security verification key off WAN; obtaining a firmware upgrade packet and a security key of that firmware upgrade packet via WAN; determine whether that security verification key match the security key of the firmware upgrade packet.

The security verification method according to the embodiment of this disclosure, wherein obtaining the firmware upgrade packet via the WAN comprises downloading the sub-upgrade packets from the server via the WAN, wherein the method further comprises: transmitting the identification code of the target terminal device; splicing the sub-upgrade packets into a target firmware upgrade packet based on the identification code of the target terminal device.

The security verification method according to the embodiment of this disclosure, wherein the method further comprises downloading the header of the firmware upgrade packet from the server, and performing: in response to all sub-upgrade packets and firmware upgrade headers being downloaded to the target terminal device, determining whether to change the sequence of downloaded sub-upgrade packets based on the sequence identification in the identification code of the target terminal device; performing a security or integrity verification on the downloaded sub-upgrade packets; in response to the downloaded sub-upgrade packet passing the security or integrity verification, running the target firmware spliced by the sub-upgrade packets.

### BRIEF DESCRIPTION OF DRAWINGS

The above and other aspects, features and advantages of specific embodiments of the disclosure will become more apparent from the following description taken in conjunction with the accompanying drawings, in which:

FIG. 1 is a flowchart of a firmware upgrade method applied to a server according to an embodiment of the disclosure;

FIG. 2 is a flowchart of a firmware upgrade method applied to a terminal device according to an embodiment of the disclosure;

FIG. 3 is a flowchart of a firmware upgrade method applied to a server according to an embodiment of the disclosure;

FIG. 4 is a flowchart of a firmware upgrade method applied to a terminal device according to an embodiment of the disclosure;

FIGS. 5A-5C are schematic diagrams of a server changes the sequence of sub-upgrade packets in an odd dimension matrix clockwise and the moving-out direction is left according to an embodiment of the disclosure;

FIG. 5D is a schematic diagram of an inverse process of a translation process of a packet according to an embodiment of the disclosure;

FIG. 6 is a flowchart for determining a way of translation of packets in an odd dimension matrix according to an embodiment of the disclosure;

FIG. 7 is a flowchart of an inverse process of a translation process of a packet according to an embodiment of the disclosure;

FIG. 8 is a flowchart for determining the number of translations performed by the server needs to be continued to recover the sequence of sub-upgrade packet according to an embodiment of the disclosure;

FIGS. 9A-9D are schematic diagrams of the manner in which a server translates packets in an odd dimension matrix according to different moving-out directions according to an embodiment of the disclosure;

FIG. 10 is a schematic diagram of a server changing the sequence of sub-upgrade packets based on sequence identification indicating that the move-out direction is left and counterclockwise according to an embodiment of the disclosure;

FIG. 11 is a schematic diagram of a server clock-wisely changes the sequence of sub-upgrade packets in an even dimensional matrix and the moving-out direction is left according to an embodiment of the disclosure;

FIG. 12 is a flowchart for determining a way of translation of packets in an even dimensional matrix according to an embodiment of the disclosure;

FIGS. 13A-13D are schematic diagrams describing the manner in which a server translates packets in an even dimensional matrix according to different moving-out directions according to an embodiment of the disclosure;

FIG. 14 is a firmware upgrade device for a server according to an embodiment of the disclosure;

FIG. 15 is a firmware upgrade device for a terminal device according to an embodiment of the disclosure;

FIG. 16 is a flowchart for secure booting of a target terminal device according to an embodiment of the disclosure;

FIG. 17 is a flowchart for security verification with a combination of off-network and on-network for target terminal device according to an embodiment of the disclosure.

### DETAILED DESCRIPTION

Before proceeding to the following detailed description, it may be beneficial to set forth the definitions of certain words and phrases used throughout this patent document. The terms “including” and “containing” and their derivatives refer to including but not limited to. The term “controller” or “control unit” refers to any device, system or part thereof that controls at least one operation. Such a controller may be implemented in hardware or a combination of hardware and software and/or firmware. The functions associated with any particular controller can be centralized or distributed, whether local or remote. The phrase “at least one”, when used with a list of items, means that different combinations of one or more of the listed items can be used, and only one item in the list may be needed. For example, “at least one of A, B, C” includes any one of the following combinations: A, B, C, A and B, A and C, B and C, A and B and C.

Definitions of other specific words and phrases are provided throughout this patent document. It should be understood by those skilled in the art that in many cases, if not most cases, this definition also applies to the previous and future uses of words and phrases so defined.

The following description of various embodiments of the principles of the disclosure in this patent application document with reference to the accompanying drawings is for illustration only and should not be interpreted as limiting the scope of the disclosure in any way. Those skilled in the art will understand that the principles of the disclosure can be implemented in any suitably arranged system or device. In some cases, the actions described in the specification can be performed in a different sequence and still achieve the desired results. Moreover, the processes depicted in the drawings do not necessarily require the specific sequence shown or sequential sequence to achieve the desired results. In certain embodiments, multitasking and parallel processing may be advantageous.

Internet of Thing (IoT) is to collect any object or process that needs to be monitored, connected and interacted in real time through various apparatus and technologies such as information sensors, radio frequency identification technology, global positioning system, infrared sensors and laser scanners. IoT collects all kinds of needed information such as sound, light, heat, electricity, mechanics, chemistry, biology, location, etc. of any object or process. The IoT realizes ubiquitous connection between things and things, things and people through all kinds of possible network access, and realizes intelligent perception, identification and management of things and processes. The IoT is an information carrier based on the Internet and traditional telecommunication networks, which enables all ordinary physical objects that can be independently addressed to form an interconnected network. Different from the traditional network security, Internet of Things security is the product of the integration of network security and other engineering disciplines. Compared with simple data, server, network infrastructure and information security, the connotation of Internet of Things security is richer. Moreover, the security of the Internet of Things also needs to include direct or distributed monitoring and control of the state of the networked physical system. There are a large number of terminal devices in the Internet of Things system, and a large part of them are single-chip devices with limited computing power and storage resources. In this equipment environment with severely limited resources, the traditional security management solutions based on operating system, such as firewall and application store, cannot guarantee the security of the equipment during the upgrade.

The terminal device of Android system is taken as an example. In some cases, the firmware can be upgraded through the application store. Although the source of the upgrade packet is legal and there is encryption processing in the transmission process and the whole upgrade process is carried out in the form of a whole packet or a sub-packet, the firmware upgrade packet and upgrade process are the same when each terminal device upgrades the same firmware, which cannot effectively avoid the security risks in the upgrade process. In other cases, the firmware upgrade packet in APK format can be downloaded from the web page to upgrade the firmware, and it is also difficult to effectively avoid the security risks in the firmware upgrade process because it involves the subjective judgment and choice of risks by users.

The embodiment of the invention provides a firmware upgrade method, a apparatus, a server, a terminal device and a storage medium, which can effectively avoid the security risks in the firmware upgrade process. Because different devices may have different identification codes, the sub-upgrade packets and firmware upgrade processes of different devices may be different, and a single device cannot leak the information of other devices when it is hacked, so it is difficult to observe the law in the network and interfere with the firmware upgrade of the terminal device in a large range. The cracking difficulty of the system is proportional to the number of terminal devices, which is especially suitable for large-scale sensor and controller networks, military and factory scenarios.

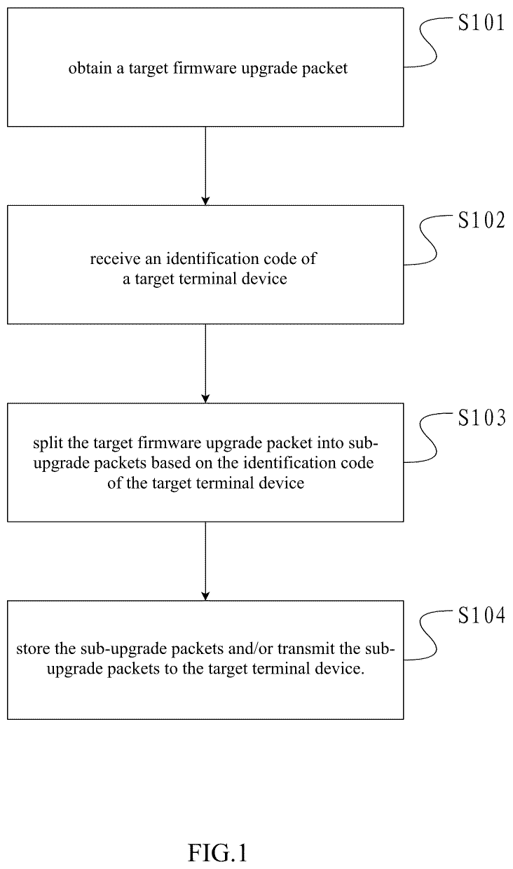

FIG. 1 is a flowchart of a firmware upgrade method applied to a server according to an embodiment of the disclosure.

In step S101, the server obtains the target firmware upgrade packet. For example, a firmware upgrade packet made by a developer can be obtained. When the developer develops the upgraded firmware, the upgraded firmware will add or rewrite the existing firmware on the device to make it operate with the highest efficiency and security again. For example, if there is a fault that needs to be solved or a new security patch is created, the currently installed firmware will no longer be applicable. For devices that frequently access the Internet or need to constantly update their security functions, firmware upgrades may be very frequent. In practical application, the firmware upgrade packet can be regarded as a whole file, which is debugged and tested by developers when making the firmware upgrade packet.

In step S102, the server receives the identification code of the target terminal device. For example, the server receives its identification code from the target terminal device.

The target terminal device can refer to the terminal device to be upgraded, and the terminal device can be any terminal device in the Internet of Things, for example, various information sensors, radio frequency identification devices, global positioning systems, infrared sensors, laser scanners, computers, etc.

In some implementations, the identification code can refer to the SN (Serial Number) code of the pre-configured terminal device, and the firmware upgrade packet in the related art is made into a unified upgrade packet file. Therefore, when upgrading the firmware of a batch of terminal device, the firmware upgrade packet and upgrade process of each terminal device are the same, and once the firmware upgrade packet is monitored during transmission (download), it is easy for the whole firmware upgrade packet to be leaked or even tampered with. Therefore, the security of terminal devices with the same firmware upgrade requirements cannot be effectively guaranteed during firmware upgrade.

In the security mechanism of firmware upgrade adopted in this embodiment, each terminal device is provided with an identification code with certain customization, and at least some fields in the identification code are configured with upgrade information, and the identification code is customized for each terminal device. Because the identification codes of terminal devices with the same firmware upgrade requirements are configured differently or not exactly the same, the specific forms of unpacking transmission (downloading) are not all consistent, so even if the information of a single terminal device is leaked, the security problems of all terminal devices in the whole system will not be brought.

In some implementations, the upgrade information includes at least one of the size of the sub-upgrade packet, the sequence identification of the sub-upgrade packet, and the download address offset of the sub-upgrade packet. Among them, the size of the sub-upgrade packet is the size of each sub-upgrade packet when splitting the sub-upgrade packet, for example, the size of the sub-upgrade packet can be transmitted by 7 bits; the sequence identification of the sub-upgrade packet is used to distinguish whether or not to change the sequence of each sub-upgrade packet and how to change the sequence of each sub-upgrade packet, so as to change the transmission sequence of the splitd sub-upgrade packet, improve the complexity in the transmission process, and prevent the whole firmware upgrade packet from being leaked or even tampered when being monitored. In practice, the sequence identification of the different sub-upgrade packet can be set randomly or according to a certain rule, and the embodiment is not limited to this.

An example of the composition of the identification code is shown in Table 1:

TABLE 1

| Header | Sequence | Sub-upgrade | Download | Tail |
|---|---|---|---|---|
| field | identification | packet size | address offset | field |
| Several | 1 bit (0 or 1) | 7 bits | Several bytes | Several |
| bytes | | (representing the | | bytes |
| | | size of the sub- | | |
| | | upgrade packet of | | |
| | | 0-127 bits) | | |

The identification codes in Table 1 include the header field, the sequence identification of the sub-upgrade packet, the size of the sub-upgrade packet, the download address offset of the sub-upgrade packet and the tail field. The position of the sequence identification of the sub-upgrade packet, the size of the sub-upgrade packet and download address offset of the sub-upgrade packet in the identification code are only schematic, and they can be located in the identification code in different sequences. The total number of bits of the identification code and various bytes (or bits) such as upgrade information, header field and tail field can be determined according to the actual identification code configuration rules. Among them, the header field and the trailer field can refer to the settings of the header field and the trailer field in SN in the related art to identify the basic information of the corresponding terminal device, and they can also be set in customized way. In some cases, the header field and the trailer field can be omitted, that is, the identification code is only configured with the upgrade information.

Step S103, the server splits the target firmware upgrade packet into sub-upgrade packets based on the identification code of the target terminal device. The server stores or transmits the split packet, in the process of upgrading. When splitting the packet, it may be necessary to input the identification number of the terminal device to be upgraded or the server automatically splits the firmware upgrade packet according to the identification number of the terminal device. In one embodiment, the server may split the target firmware upgrade packet into a number of sub-upgrade packets based on the size of the target firmware upgrade packet and the size of the sub-upgrade packet in the identification code of the target terminal device. Alternatively, the server may split the target firmware upgrade packet into several sub-upgrade packets based on the size of the target firmware upgrade packet and the size of the predetermined sub-upgrade packet or based on other mechanisms. In one embodiment, the server can determine whether to change the sequence of the sub-upgrade packets and how to change the sequence of the sub-upgrade packets based on the sequence identification of the sub-upgrade packets in the identification code of the target terminal device.

In step S104, the server stores and/or transmits the sub-upgrade packet to the target terminal device. The server will store each sub-upgrade packet file in the server and transmit it when the firmware of the target terminal device is upgraded. Alternatively or additionally, when the current target terminal device is in firmware upgrade, the sub-upgrade packet file is transmitted to the target terminal device. In practical application, the server can store several split sub-upgrade packets in advance, and start transmitting the sub-upgrade packets to the target terminal device when the terminal device requests it. Alternatively or additionally, the server may automatically transmit the sub-upgrade packets to the target terminal device. In one embodiment, several split sub-upgrade packets can be stored and transmitted to the target terminal device at the same time to realize backup. In one embodiment, the server can determine the address where the sub-upgrade packet is stored based on the identification code of the target terminal device, so that the terminal device can download the sub-upgrade packet from this address. For example, the server may receive the identification code sn001 of the terminal device from the terminal device. The server the sub-upgrade packets in stores the PROTOCOL://HOSTNAME/PATH/sn001 based on the default modifiable address PROTOCOL://HOSTNAME/PATH/SN and the identification code sn001 of the target terminal device. The target terminal device can download the sub-upgrade packet from the address PROTOCOL://HOSTNAME/PATH/sn001. The specific form of the above address is exemplary, not restrictive. Alternatively, the server may store the sub-upgrade packet at a predetermined address for the terminal device to download the sub-upgrade packet from the predetermined address.

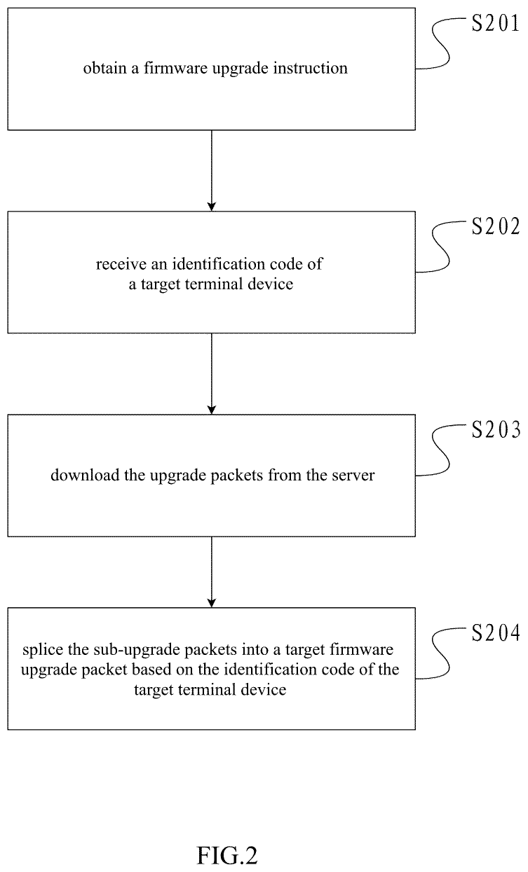

FIG. 2 is a flowchart of a firmware upgrade method applied to a terminal device according to an embodiment of the disclosure. The terminal device can be various Internet of Things terminal device, for example, smart sensors (such as sensors for collecting ambient data such as temperature, humidity, vibration, pressure, liquid level, etc.), smart home devices (such as smart plug, smart lights, smart stereos, smart washing machines, smart refrigerators, smart air purifiers, etc.), and smart wearable devices (such as smart watches, sports bracelets, smart glasses, etc.), intelligent transportation equipment (such as intelligent street lamps, intelligent cars, intelligent parking lots, etc.), intelligent medical care equipment (such as intelligent sphygmomanometer, intelligent health bracelet, intelligent paging machine), intelligent industrial equipment (such as CNC machine tools, industrial robots), etc. The above terminal device can be realized by embedded technology or other technologies.

In step S201, the terminal device obtains a firmware upgrade instruction. In some implementations, the firmware upgrade instruction is transmitted by the broadcast device off the WAN or triggered by the preset key of the terminal device. The broadcast device off the WAN may be a handheld broadcast device, for example. Broadcasting device that is off the WAN can be realized by short-range wireless communication such as Bluetooth, Bluetooth LE, ZigBee, Radio Frequency Identification (RFID), UWB, 60 GHz, Wi-Fi, WiMAX or wired communication such as USB. Because the broadcasting device is separated from the WAN, the security risks when transmitting through the WAN can be well avoided without using the WAN. Terminal device can also preset keys, such as physical keys such as toggle keys, sliding keys and buttons, and specific areas displayed on the touch screen, so as to trigger firmware upgrade instructions and realize the upgrade strategy of off-network and on-network cooperation. In one embodiment, the firmware upgrade instruction can be trasnmitted by the server to the terminal device through the WAN. In practical application, according to the requirement of firmware upgrade, one or more of manners of the firmware upgrade instructions transmitted by broadcast device, the firmware upgrade instructions triggered by preset keys of terminal device and the firmware upgrade instructions transmitted by server through WAN can be selected.

In step S202, the terminal device transmits the identification code of the target terminal device. For example, the terminal device can obtain the identification code of the target terminal device from the storage area of the flash chip of the terminal device. The identification code of the target terminal device has already been described in step S102 of FIG. 1, and the description is not repeated here.

In step S203, the terminal device receives (downloads) the sub-upgrade packets. In one embodiment, the terminal device can download the sub-upgrade packet from the server.

In one embodiment, the identification code may also include a storage address offset, but this is not necessary. For example, the terminal device stores the sub-upgrade packet in a storage address of a flash of the terminal device determined based on the modifiable storage address and the storage address offset. So as to realize the partition storage of the sub-upgrade packets in the terminal device. The storage address offset of the sub-upgrade packets is used to determine the storage address of the sub-upgrade packet in the terminal device, so as to realize the partition storage of the sub-upgrade packets in the terminal device. In practical application, the sub-upgrade packets are stored in the flash chip of the terminal device, and the sub-upgrade packets are partitioned and stored in the terminal device by partitioning different storage areas in the flash chip.

Examples of storage area partition of terminal device flash chip are shown in Table 2:

TABLE 2

| storage | | |
|---|---|---|
| address | function | Notes |
| 00000000 | Storage address of | SN consists of 16 |
| | identification code (SN) | bytes. |
| 0000000F | Modifiable download address | The modifiable |
| | (PROTOCOL://HOSTNAME/PATH/SN) | download address is a |
| | | string, and the string |
| | | represents the |
| | | firmware download |
| | | address that the |
| | | terminal device can |
| | | modify according to |
| | | the identification code |
| | | of the terminal device. |
| 00000500 | 1st packet storage address | It can be determined |
| | | by modifiable storage |
| | | address and |
| | | identification code. |
| 0000057F | 2nd packet storage address | It can be determined |
| | | by modifiable storage |
| | | address and |
| | | identification code. |
| 000005FF | 3rd packet storage address | It can be determined |
| | | by modifiable storage |
| | | address and |
| | | identification code. |
| . . . | . . . | It can be determined |
| | | by modifiable storage |
| | | address and |
| | | identification code. |
| FFFFFF7F | Tmp packet reserved address | It can be determined |
| | | by modifiable storage |
| | | address and |
| | | identification code. |

It can be seen that the sub-upgrade packets are partitioned and stored in the terminal device by partitioning different storage areas in the flash chip.

In one embodiment, the terminal device can determine the address of downloading the sub-upgrade packet from the server based on the identification code of the terminal device and the default modifiable download address read from the flash chip of the terminal device according to the download address offset. For example, in the example in Table 2, the terminal device can obtain the download address offset address_offset001 of the target terminal device based on the identification code read from the 0000000 address of the flash chip. And the terminal device can read the modifiable address PROTOCOL://HOSTNAME/PATH/SN from the address 0000000F of the flash chip based on the address_offset001, and determine to download the sub-upgrade packet stored in the server from the PROTOCOL://HOSTNAME/PATH/sn001 according to identification code sn001 of the terminal device and the modifiable address PROTOCOL://HOSTNAME/PATH/SN. The specific form of the above address is exemplary, not restrictive. Alternatively, the terminal device may download the sub-upgrade packet from a predetermined address.

In step S204, the sub-upgrade packets are spliced into a target firmware upgrade packet based on the identification code of the target terminal device. For example, the terminal device can determine whether to change the sequence of the received sub-upgrade packets and how to change the sequence of the sub-upgrade packets based on the sequence identification of the sub-upgrade packets in the identification code of the target terminal device, so as to further splice the sub-upgrade packets into the target firmware upgrade packet. In one embodiment, splicing may refer to reading the sub-upgrade packets from the storage area of the target terminal device in sequence. In some embodiments, after the sub-upgrade packets are spliced into the target firmware upgrade packet, a soft restart is also performed.

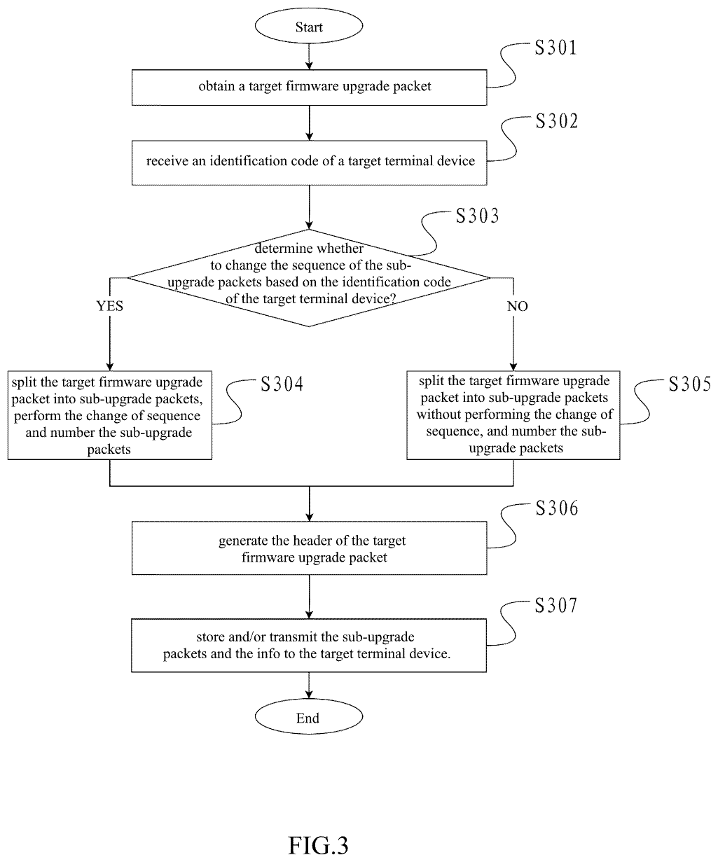

FIG. 3 is a flowchart of a firmware upgrade method applied to a server according to an embodiment of the disclosure.

In step S301, the server obtains the target firmware upgrade packet. The part of step S301 in FIG. 3 that is similar to step S101 in FIG. 1 is not repeated here.

In step S302, the server receives the identification code of the target terminal device. The part of step S302 in FIG. 3 that is similar to step S102 in FIG. 1 is not repeated here.

In step S303, the server determines whether to change the sequence of the sub-upgrade packets based on the identification code of the target terminal device. When it is determined that the sequence of sub-upgrade packets will be changed, the flow proceeds to S304. In S304, the server splits the target firmware upgrade packet into sub-upgrade packets, performs the change of sequence, and numbers the sub-upgrade packets. When it is determined that the sequence of sub-upgrade packets will not be changed, the flow proceeds to S305. In S304, the server splits the target firmware upgrade packet into sub-upgrade packets without performing the change of sequence, and numbers the sub-upgrade packets. In one embodiment, the number of each sub-upgrade packets on the server is 0001, 0002, 0003, 0004, 0005. No matter whether the sequence of each sub-upgrade packet is changed or not, the numbers are written in sequence, which indicates the transmission sequence of each sub-upgrade packet. In one embodiment, the header of each sub-upgrade packet may include the number of the sub-upgrade packets. In one embodiment, the header of each sub-upgrade packet may also include the identification code of the target terminal device and the quantity of sub-upgrade packets.

In one embodiment, the sequence identification may be binary data. But the binary data is only exemplary, and in other embodiments, the sequence identification can be other forms of identification.

In some implementations, in step S303, it is determined whether to change the sequence of each sub-upgrade packet while splitting the target firmware upgrade packet into several sub-upgrade packets according to whether the value corresponding to the binary data with preset number of bits is a predetermined value (for example, 0). The security of the transmission (download) of the firmware upgrade packet can be improved by determining and adjusting the sequence of the sub-upgrade packets when splitting the firmware upgrade packet by the sequence identification.

For example, a specific change of sequence rule may be that in S304, several sub-upgrade packets are divided into several pairs of adjacent sub-upgrade packets, and the sequence of two sub-upgrade packets in each pair of adjacent sub-upgrade packets is exchanged. After changing the sequence of the sub-upgrade packets according to this rule, the difficulty of being intercepted, leaked and tampered with when transmitting (downloading) the firmware upgrade packet is obviously increased, and the security of firmware upgrade is improved.

In one example, if the preset number of bits is 1, the binary data includes 0 or 1, and the corresponding numerical value is also 0 or 1. Further, in step S303, when the numerical value corresponding to the binary data corresponding to the sequence identification in the identification code of the current terminal device is 0, the target firmware upgrade packet is split into several sub-upgrade packets while the sequence of each sub-upgrade packet remains unchanged; and when the numerical value corresponding to the binary data corresponding to the sequence identification in the identification code of the current terminal device is 1, the target firmware upgrade packet is split into several sub-upgrade packets while the sequence of each sub-upgrade packet is changed. Alternatively, the setting opposite to the above can be made.

In some implementations where the preset number of bits is 1 bit, in S304, adjacent sub-upgrade packets may be exchanged in sequence to realize the change of sequence of the sub-upgrade packets. Therefore, the sequence of each sub-upgrade packet is changed according to the numerical value corresponding to the binary data with preset number of bits, including: dividing a plurality of sub-upgrade packets into a plurality of pairs of adjacent sub-upgrade packets; and exchanging the sequence of two sub-upgrade packets in each pair of adjacent sub-upgrade packets. Continuing with the previous example, if the preset number of bits is 1, the binary data includes 0 or 1. When the numerical value corresponding to the sequence identification in the identification code of the current terminal device is 1, it is determined to change the sequence of each sub-upgrade packet. At this time, several sub-upgrade packets obtained by splitting the target firmware upgrade packet are divided into several pairs of adjacent sub-upgrade packets, and the sequence of two sub-upgrade packets in each pair is changed. However, when the numerical value corresponding to the sequence identification in the identification code of the current terminal device is 0, this sequence exchange operation is unnecessary and the original sequence can be maintained.

In another example, if the preset number of bits is 2, the binary data includes 00, 01, 10, and 11, and the corresponding numerical values are 0, 1, 2, and 3. Further, in step S303, when the numerical value corresponding to the sequence identification in the identification code of the current terminal device is 0, the target firmware upgrade packet is split into several sub-upgrade packets while the sequence of each sub-upgrade packet remains unchanged. However, when the corresponding binary data 01, 10 or 11 in the identification code of the current terminal device are 1, 2 and 3, the target firmware upgrade packet is divided into several sub-upgrade packets, and the sequence of each sub-upgrade packet needs to be changed. Alternatively, a setting different from the above setting may be made.

In some implementations, in step S303, it is also possible to determine whether to perform the change of sequence of the sub-upgrade packets according to the parity of the numerical values corresponding to the binary data with preset number of bits. Therefore, according to the numerical value corresponding to the binary data with preset number of bits, determining whether to change the sequence of each sub-upgrade packet while splitting the target firmware upgrade packet into several sub-upgrade packets, including: if the numerical value corresponding to the binary data with preset number of bits is even, it is determined that the sequence of each sub-upgrade packet remains unchanged while splitting the target firmware upgrade packet into several sub-upgrade packets; if the number of binary data corresponding to the preset number of bits is odd, it is determined that the sequence of each sub-upgrade packet is changed while splitting the target firmware upgrade packet into several sub-upgrade packets. Alternatively, if the number of binary data corresponding to the preset number of bits is odd, it is determined that the sequence of each sub-upgrade packet remains unchanged while splitting the target firmware upgrade packet into several sub-upgrade packets; if the numerical value corresponding to the binary data with preset number of bits is even, it is determined that the sequence of each sub-upgrade packet is changed while splitting the target firmware upgrade packet into several sub-upgrade packets. When the preset number of bits is 1 bit, the process of determining whether to change the sequence of sub-upgrade packets according to parity is similar to the process of determining whether to change the sequence of sub-upgrade packets according to whether the sequence identification is 0 or 1.

In some implementations, in step S303, it is also possible to determine whether to perform the change of sequence of the sub-upgrade packets by taking the remainder of the numerical value corresponding to the binary data with preset number of bits over predetermined value. Therefore, determining whether to perform the change of sequence of the sub-upgrade packets by taking the remainder of the numerical value corresponding to the binary data with preset number of bits over predetermined value, includes: if the taken remainder of the numerical value corresponding to the binary data with preset number of bits over predetermined value is one of one or more specific numerical values, it is determined that the sequence of each sub-upgrade packet is unchanged while splitting the target firmware upgrade packet into several sub-upgrade packets; if the taken remainder of the numerical value corresponding to the binary data with preset number of bits over predetermined value is not one of one or more specific numerical values, it is determined that the sequence of each sub-upgrade packet is changed while splitting the target firmware upgrade packet into several sub-upgrade packets. Alternatively, if the taken remainder of the numerical value corresponding to the binary data with preset number of bits over predetermined value is one of one or more specific numerical values, it is determined that the sequence of each sub-upgrade packet is changed while splitting the target firmware upgrade packet into several sub-upgrade packets; if the taken remainder of the numerical value corresponding to the binary data with preset number of bits over predetermined value is not one of one or more specific numerical values, it is determined that the sequence of each sub-upgrade packet is unchanged while splitting the target firmware upgrade packet into several sub-upgrade packets. For example, when the predetermined value is 3, the taken remainder of the numerical value corresponding to the binary data with preset number of bits over predetermined value is a specific numerical value (for example, 0), it can be determined whether to change the sequence of each sub-upgrade packet while splitting the target firmware upgrade packet into several sub-upgrade packets. When the predetermined value is 2, the process of determining whether to perform the change of sequence of the sub-upgrade packets by taking the remainder of the numerical value corresponding to the binary data with preset number of bits over predetermined value is similar to the process of determining whether to exchange the sequence of the sub-upgrade packets according to parity.

In some implementations, the rules of exchange of sequence can be determined according to the corresponding numerical values of binary data with preset bits. Therefore, in step S304, changing the sequence of each sub-upgrade packet according to the numerical value corresponding to the binary data with preset number of bits, including: dividing the sub-upgrade packets into several sub-upgrade packet groups, each sub-upgrade packet group includes a specific quantity of sub-upgrade packets, and the specific quantity is the numerical value plus 1, the numerical value corresponds to the maximum binary data of the preset number of bits; and the sequence of two sub-upgrade packages in each group of sub-upgrade packages which are different in sequence from the numerical value corresponding to the binary data of the preset number of bits is exchanged . . .

Continuing the previous example, when the preset number of bits is 2, the binary data includes 00, 01, 10 and 11, and the numerical value corresponding to the maximum binary data of 2 bits corresponds to 3. Further, when the numerical value corresponding to binary data 00 corresponding to the sequence identification in the identification code of the current terminal device is 0, the target firmware upgrade packet is split into several sub-upgrade packets, while the sequence of each sub-upgrade packet remains unchanged, so it is unnecessary to exchange. However, when the numerical value corresponding to binary data 01, 10 or 11 corresponding to the sequence identification in the identification code of the current terminal device are 1, 2 and 3, the target firmware upgrade packet needs to be split into several sub-upgrade packets and the sequence of each sub-upgrade packet needs to be changed. The binary data corresponding to the sequence identification as 10 is take as an example, and the corresponding numerical value is 2. At this time, the specific way of the change of the sequence is: divide several sub-upgrade packets into several groups, each group contains 4 sub-upgrade packets (namely, 1+ the numerical value 3 corresponding to the maximum binary data), wherein the first group includes the Oth packet, the 1st packet, the 2nd packet and the 3rd packet, and The sequence of two sub-upgrade packets with a difference of two bits in sequence is exchanged, that is, the Oth packet is exchanged with the 2nd packet and the 1st packet is exchanged with the 3rd packet. When the preset number of bits is 1, the process of grouping the sub-upgrade packets according to the numerical value corresponding to the maximum binary data of the preset number of bits plus 1 and changing the sequence of the sub-upgrade packets according to the numerical value corresponding to the maximum binary data of the preset number of bits is similar to the process of dividing the sub-upgrade packets into several pairs of adjacent sub-upgrade packets and changing the sequence of two sub-upgrade packets in each pair. Based on the similar principle, the case that the preset number of bits is 3 bits, 4 bits . . . n bits will not be given as examples one by one in this embodiment. The more preset number of bits and/or the more complicated the rule of the exchange of sequence, the higher the transmission (download) complexity in the firmware upgrade process.

Although some of the above embodiments associates the way of determining whether to change the sequence and how to change the sequence with the preset number of bits of sequence identification. But the disclosure is not limited thereto. For example, in the embodiment where the preset number of bits is 1, the binary data includes 0 or 1, and the corresponding numerical value is also 0 or 1. Further, in step S303, when the numerical value corresponding to the binary data corresponding to the sequence identification in the identification code of the current terminal device is 0, the target firmware upgrade packet is split into several sub-upgrade packets while the sequence of each sub-upgrade packet remains unchanged, and when the numerical value corresponding to the binary data corresponding to the sequence identification in the identification code of the current terminal device is 1, the target firmware upgrade packet is split into several sub-upgrade packets while the sequence of each sub-upgrade packet is changed. However, the way of the change of the sequence may be that the sub-upgrade packets are divided into several sub-upgrade packet groups, and each sub-upgrade packet group includes a certain quantity of upgrade packets, which is the quantity (greater than or equal to 2) previously scheduled by the server and the target terminal device; and the sequence of two sub-upgrade packages in each group whose sequence differs by this quantity minus 1 (or other numerical value whose sequence differs by less than this number, for example, the sequence differs by less than this quantity minus 2, etc.) is exchanged. For example, in the embodiment of determining whether to perform the change of sequence of the sub-upgrade packets by taking the remainder of the numerical value corresponding to the binary data of the preset number of bits over predetermined value, the way of change of sequence of the sub-upgrade packets of the target terminal devices with different remainders can be set between the server and the target terminal device. For example, when the remainder is 0, the sequence of the sub-upgrade packets may not be changed. When the remainder is 1, the sub-upgrade packets can be divided into several pairs of adjacent sub-upgrade packets, and the sequence of two sub-upgrade packets in each pair of adjacent sub-upgrade packets can be exchanged. When the remainder is 2, several sub-upgrade packets can be divided into several groups, each group contains 3 sub-upgrade packets (that is, the remainder plus 1), and the sequence of two sub-upgrade packets with a difference of 2 (that is, the remainder) can be exchanged. But the disclosure is not limited thereto.

In S306, the server generates the header of the target firmware upgrade packet. The header of the target firmware upgrade packet may include one or more of the identification code of the target terminal device, the quantity and number of sub-upgrade packets, the firmware upgrade key and/or integrity verification information. The firmware upgrade key and/or integrity verification information can be used for security verification of the terminal device in the security boot process.

In S307, the server stores and/or transmits the sub-upgrade packet and the info packet to the target terminal device. The info packet is equivalent to the packet that provides the header of the target firmware upgrade packet. The parts in S307 of FIG. 3 that are similar to S104 of FIG. 1 are not repeated.

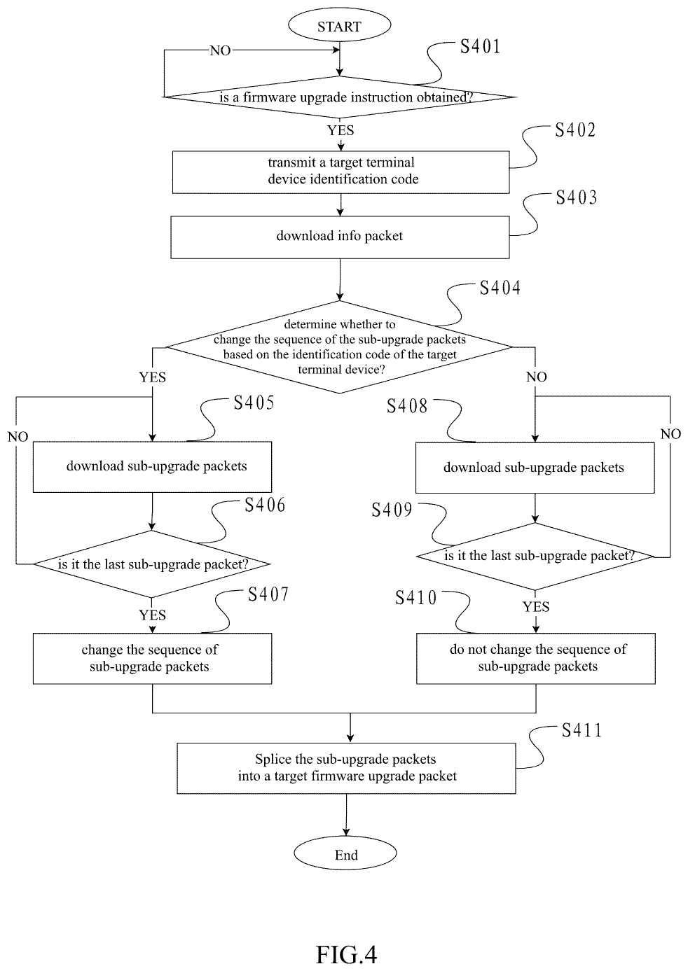

FIG. 4 is a flowchart of a firmware upgrade method applied to a terminal device according to an embodiment of the disclosure.

In S401, the terminal device obtains a firmware upgrade instruction. The part of step S401 in FIG. 4 that is similar to step S201 in FIG. 2 is not repeated here.

In S402, the terminal device transmits the identification code of the target terminal device. The part of step S402 in FIG. 4 that is similar to step S202 in FIG. 2 is not repeated here.

In S403, the terminal device downloads the info packet. The terminal device obtains one or more of the identification code of the target terminal device, the quantity of sub-upgrade packets, the firmware upgrade key and/or the integrity verification information through the downloaded info packet. For example, it can be verified whether the identification code of the target terminal device in the info packet is consistent with the identification code of this terminal device. Under the condition that the identification code of the terminal device is consistent with the identification code in the info packet transmitted by the server, the sub-upgrade packet split based on the upgrade information transmitted by the server is downloaded. If the obtained identification code of the terminal device is inconsistent with the identification code in the header transmitted by the server, the current firmware upgrade instruction may be illegal, and the download operation is not performed.

The server can transmit GET information (info packet with header information) to the terminal device. GET information may include the identification code SN of the terminal device, the quantity of the sub-upgrade packets split, the number of the sub-upgrade packets split, the integrity check value, such as md5 value, the firmware upgrade key and other security verification information. In practical application, more and more types of security verification information can be set according to the security requirements, so as to realize the security verification of the terminal device and improve the security of firmware upgrade.

In some cases, the header may also include a firmware upgrade key and/or integrity verification information to verify with the firmware upgrade key and/or integrity verification information carried in the firmware upgrade instruction, so as to improve security.

The info packet transmitted by the server is downloaded and stored in the preset tmp partition of the terminal device for calling the information in the upgrade process.

In the process of downloading the sub-upgrade packets split based on the upgrade information transmitted by the server, the way of requesting packet-by-packet transmission and downloading can be adopted, and in the case of downloading sub-upgrade packet one by one, it can be determined whether the last sub-upgrade packet is downloaded according to the information provided by the header. Therefore, in some implementations, the method further includes determining whether to download the last sub-upgrade packet according to the quantity of sub-upgrade packets in the header.

Because the quantity and number of sub-upgrade packets are determined, when downloading each sub-upgrade packet in sequence, it can be determined that whether all sub-upgrade packets have been transmitted according to the number of the sub-upgrade packet.

In S404, the terminal device determines whether to change the sequence of the sub-upgrade packets based on the identification code.

When it is determined that the sequence of the sub-upgrade packets is changed, the flow proceeds to S405. In S405, the terminal device downloads the sub-upgrade packets. In S406, the terminal device confirms whether the currently downloaded sub-upgrade packet is the last upgrade packet. When the currently downloaded sub-upgrade packet is not the last upgrade packet, the flow proceeds to S405. When the currently downloaded sub-upgrade packet is the last upgrade packet, the flow proceeds to S407. In S407, the terminal device changes the sequence of the sub-upgrade packets.

When it is determined that the sequence of the sub-upgrade packet is not to be changed, the flow proceeds to S408. In S408, the terminal device downloads the sub-upgrade packet. In S409, the terminal device confirms whether the currently downloaded sub-upgrade packet is the last upgrade packet. When the currently downloaded sub-upgrade packet is not the last upgrade packet, the flow proceeds to $408. When the currently downloaded sub-upgrade packet is the last upgrade packet, the flow proceeds to S410. In S410, the terminal device does not change the sequence of the sub-upgrade packets.

Therefore, when the terminal device finishes downloading the sub-upgrade packet, it first determines whether to perform the change of the sequence on the sub-upgrade packet based on the sequence identification, and if it is necessary to perform the change of the sequence on the sub-upgrade packet, it will change the sequence of the sub-upgrade packet back to the original sequence, and then splice each sub-upgrade packet into the original firmware upgrade packet; if it is not necessary to change the sequence of the sub-upgrade packets, all the sub-upgrade packets can be directly spliced into the original firmware upgrade packet.

In S411, the terminal device splices the sub-upgrade packet into a target firmware upgrade packet.

In S404, the process that the terminal device determines whether to change the sequence of the sub-upgrade packets based on the identification code, and in S406, the process that the terminal device changes the sequence of the sub-upgrade packets and splices the sub-upgrade packets with changed sequence is similar to steps 303 and 304 in FIG. 3, and the description is not repeated here.

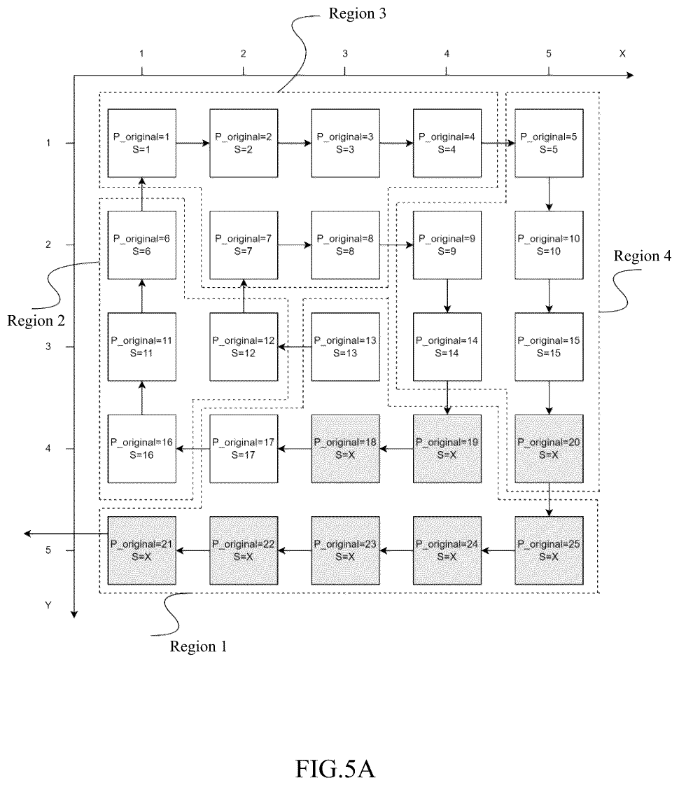

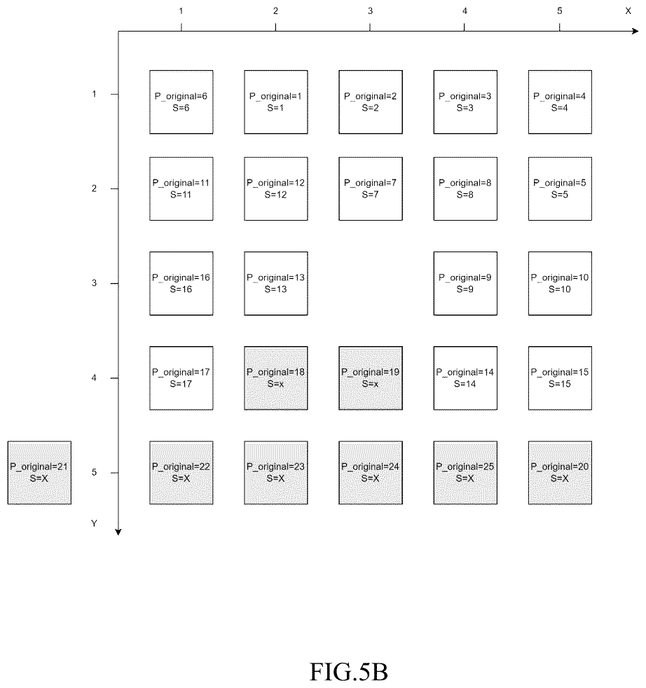

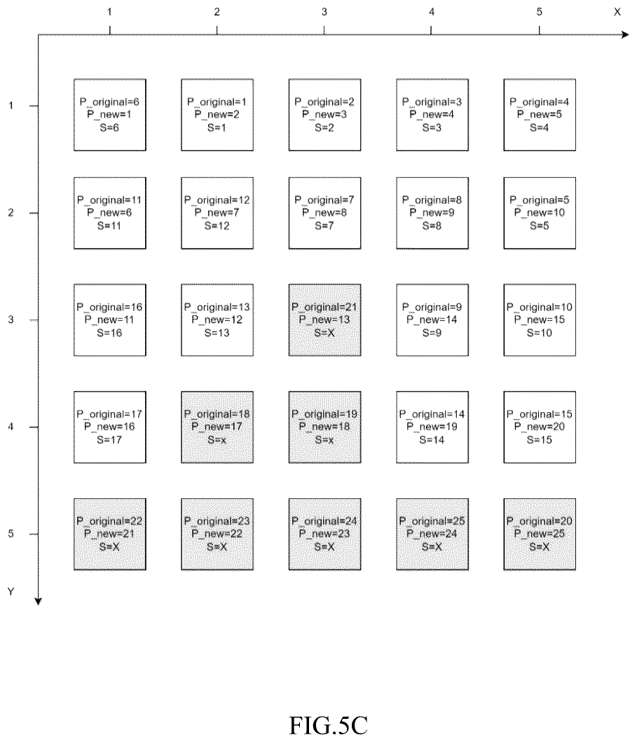

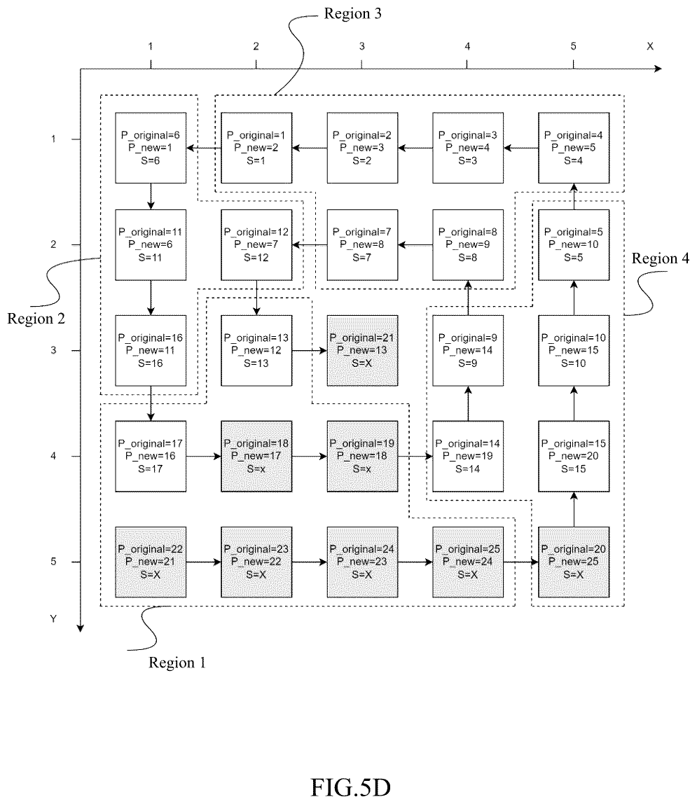

FIGS. 5A-5C are schematic diagrams of a server changes the sequence of sub-upgrade packets in an odd dimension matrix clockwise and the moving-out direction is left according to an embodiment of the disclosure.

In FIGS. 5A-5C, the process of splitting the sub-upgrade packets by the server based on the identification code of the target terminal device is similar to the process described in relation to FIG. 3, and the description is not repeated.

In one embodiment, the sequence identification in the identification code may include data with preset bits indicating at least one of number of translation, moving-out direction and rotation direction, respectively. When the sequence identification includes data with preset bits indicating one or two of number of translation, moving-out direction and rotation direction respectively, the remaining parts of number of translation, moving-out direction and rotation direction can be predetermined in advance between the terminal device and the server. Depending on needs, the number of translations can be 1, 2, 3 or more. Move-out direction refers to the translation direction of sub-upgrade packets or packets that are moved out of the matrix when the sub-upgrade packets or other packets are translated. Depending on the need, the moving-out direction can be up, down, left, right or other directions. Depending on the need, the rotation direction can be clockwise or counterclockwise. For example, when the number of translations is 2, the moving-out direction is left and the rotation direction is clockwise, all the packets in the matrix may be translated twice, and the moving-out direction of the data moved out of the matrix is left and the rotation direction of the packets in the matrix is clockwise. When the number of translations indicated by the sequence identification in the identification code is not 0, the sequence of the upgrade packets can be determined to be changed.

The server generates a matrix according to the quantity n of sub-upgrade packets that the target upgrade packet is split. In one embodiment, the server determines the dimension of the generated matrix according to the quantity n of sub-upgrade packets in which the target upgrade packet is split. T is calculated according to the following formula:

$$T = roundup ( \sqrt{N} ) \qquad ( 1 )$$

Where roundup ( ) means rounding up.

T is subjected to the remainder operation of 2, and when the remainder is 0, a matrix with even dimensions is used. When the remainder is 1, a matrix with odd dimensions is used.

Next, with reference to FIG. 5A, the way to change the sequence of sub-upgrade packets using odd-numbered matrices will be described.

It is assumed that there are N=17 sub-upgrade packets. According to equation (1), T=5, and the remainder of t over 2 is taken as 1, so it can be determined to generate a matrix with odd dimensions. When generating a matrix with odd dimensions, the dimensions of the matrix are determined by the following equation:

$$n = roundup ( \frac{\sqrt{N} - 1}{2} ) \qquad ( 2 )$$

According to equation (2), n=2, then the dimension of the odd matrix is 2n+1=5. That is, in the case of N=17 sub-upgrade packets, a 5-dimensional matrix as shown in FIG. 5A is generated. As shown in FIG. 5A, 17 sub-upgrade packets with initial numbers S of 1-17 are arranged in the matrix automatically from left to right. The above arrangement is merely exemplary, and other arrangements can be used. Each position of the matrix from left to right and from top to bottom has the original sequence number P_original. As shown in FIG. 5A, the 17 sub-upgrade packets cannot just fill the 5-dimensional matrix, and the matrix can be filled with interference packets (garbled packets, empty packets, or one or more of the reused 17 sub-upgrade packets) until the matrix is filled.

It is assumed that the sequence identification includes data with a preset number of bits indicating that the number of translation k is 1, the moving-out direction is left, and the rotation direction is clockwise. As shown in FIG. 5A, the packet (P_original=21) with coordinates (1,5) is translated to the left out of the matrix, and the packet rotates clockwise in the matrix. After the packet with coordinates (1, 5) is translated out of the matrix to the left, the matrix is shown in FIG. 5B. Then, the packets moved out of the matrix are filled in the vacant position in the middle of FIG. 5B, and the translated matrix is shown in FIG. 5C. The matrix of FIG. 5C is the matrix after the matrix of FIG. 5A is translated left and clockwise once.

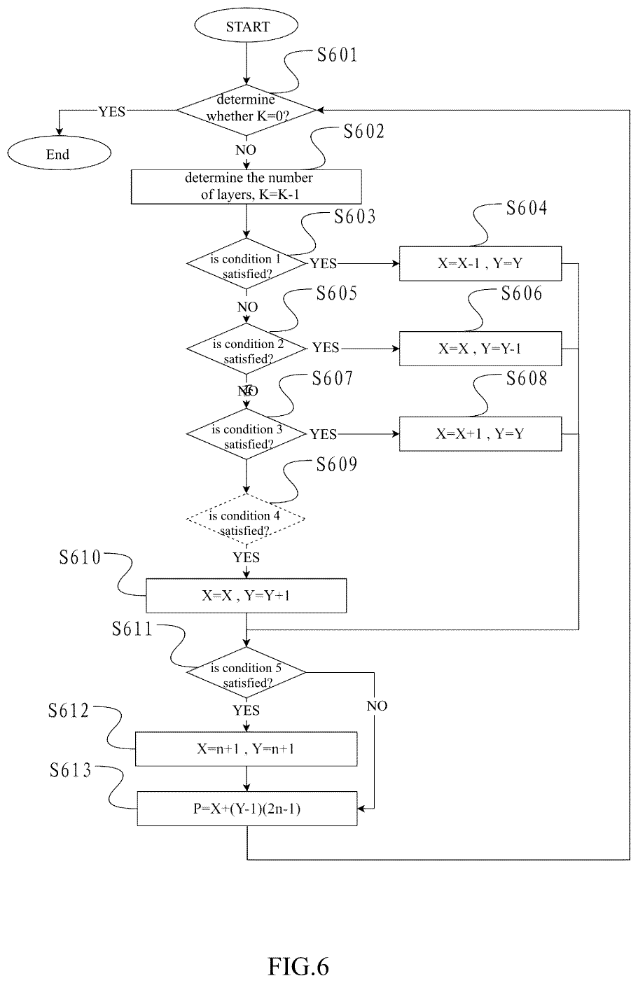

FIG. 6 is a flowchart for determining a way of translation of packets in an odd dimension matrix according to an embodiment of the disclosure.

Referring to FIG. 5A and FIG. 6, the process of determining the way of translation of each packet in the matrix is described. The following process for a packet in the matrix is performed.

In S601, it is determined whether the number of translation k is 0. The number of translation K=1, and the flow proceeds to S602.

In S602, the layer number of the packet (which is a sub-upgrade packet) with the original sequence number P_original in the matrix can be determined according to the original sequence number P_original. The original sequence number P_original=13 of the packet located in the center of FIG. 5A is taken as an example.

$$P\_original / ( 2 n + 1 ) = ( Y - 1 ) …… X \qquad ( 3 )$$

Where (Y−1) is the quotient and x is the remainder. Equation (3) shows that the coordinate (x, y)=(3,3) of the sub-upgrade packet in the matrix is determined according to the original serial number P_original=13.

$$Layer = max ( \vert X - n - 1 \vert , \vert Y - n - 1 \vert ) \qquad ( 4 )$$

Where max (|X−n−1|,|Y−n−1|) means to take the maximum value of |X−n−1| and |Y−n−1|. According to equation (4), it can be calculated that the layer number of the packet with original sequence number P_original=13 in the matrix is Layer-0. At the same time, subtract 1 from the value of K, that is, K′=K−1, K′=0 and K=K′.

In the case of translation to the left, according to the number of layers of the packet in the matrix and the coordinates of the packet in the matrix, the way of translation of the packet in the matrix can be determined by the following conditions:

Condition 1: the coordinate of the packet Y=(n+1)+Layer.

In S603, if the condition 1 is satisfied, the flow proceeds to S604, and the coordinate of the packet is changed as follows: the value of X is reduced by 1, Y and the value of Y remains unchanged; if condition 1 is not satisfied, the flow proceeds to S605.

In FIG. 5A, a packet satisfying condition 1 corresponds to a packet translated to the left, that is, a packet included in a dashed region 1.

Condition 2: the coordinate of the packet is X=n+1−Layer and n+1−Layer<Y<n+1+Layer.

In S605, if the condition 2 is satisfied, the flow proceeds to S606, and the coordinate of the packet is changed as follows: the value of X is unchanged, and the value of Y is reduced by 1; if the condition 2 is not satisfied, the flow proceeds to S607.

In FIG. 5A, the packet satisfying the condition 2 corresponds to the packet translated upward, that is, the packet included in the dashed region 1.

Condition 3: the coordinate of the packet is Y=n+1−Layer and n+1−Layer<=X<n+1+Layer.

In S607, if the condition 3 is satisfied, the flow proceeds to S608, and the coordinate of the packet is changed as follows: add 1 to the value of X, and the value of Y remains unchanged; if condition 3 is not satisfied, the flow proceeds to S609.

In FIG. 5A, a packet satisfying the condition 3 corresponds to a packet translated to the right, that is, a packet included in the dashed region 3.

Condition 4: the coordinate of the packet is Y=n+1−Layer and n+1−Layer<=X<n+1+Layer,

In S609, if the condition 4 is satisfied, the flow proceeds to S610, and the coordinate of the packet is changed to: the value of X is unchanged, and the value of Y is increased by 1.

In FIG. 5A, a packet satisfying the condition 4 corresponds to a packet translated downward, that is, a packet included in the dashed region 4.

It should be understood by those skilled in the art that, in this embodiment, besides moving into the matrix, there are four way of translations of the packet within the matrix, and under the condition that three of the above four conditions are obtained, the way of translation of the packet can be determined by the exclusion method. The selection and execution sequence of Condition 1-Condition 4 in FIG. 6 are only exemplary.

Condition 5: The coordinate x of the moved packet=0.

In S611, if the condition 5 is satisfied, the flow proceeds to S612, and the coordinates of the packet are changed to X=n+1 and Y=n+1, and then the flow proceeds from S612 to S613. If condition 5 is not satisfied, the flow proceeds directly to S613.

As shown in FIG. 5A, the packet with original sequence number P_original=13 meets condition 1 and is located in the dashed region 1 in the matrix, and the way of translation of the packet with original sequence number P_original=13 is left translation. The new sequence number of the translated packet with original sequence number P_original=13 is P_new=X+ (Y−1) (2n+1)=12, as shown in FIG. 5C. The packet with original sequence number P_original=21 meets the condition 1, which is located in the dashed region 1 in the matrix, and the way of translation of the packet with original sequence number P_original=21 is left translation. The coordinate of the translated packet with original sequence number P_original=21 is (0,5), which meets condition 5. The coordinate of the packet with original sequence number P_original=21 is changed to (3,3), so the new sequence number of the translated packet with original sequence number P_original=21 is p_new=x+ (y−1) (2n+1)=13, as shown in FIG. 5C.

The flow continues to S601, and the current K=0, and the flow ends.

By repeating the process of FIG. 6 for each packet in the matrix, the way of translation of all packets in the matrix can be obtained.

The above is how the server translates the packets in the matrix when the number of translation is 1. Those skilled in the art can understand the process of translating more times based on FIGS. 5A-5C and 6.

After the server has translated all the packets in the matrix for k times, P_new in the translated matrix is taken as the number S of the packets in the matrix and all the packets are transmitted to the target terminal device. In the process of transmitting, the sequence of sub-upgrade packets is disturbed and mixed with interference packets, which greatly increases the difficulty of cracking.

The target terminal device can determine the way (e.g., moving-out direction and clockwise and counterclockwise) and the number of times that the received packet is translated by the server based on the sequence identification in the identification code read from flash. Based on the quantity of sub-upgrade packets included in the info packet, the target terminal device can obtain the total quantity of packets (including sub-upgrade packets and interference packets, for example) in the matrix generated by the target terminal device transmitted by the server and the dimensions of the matrix generated by the target terminal device. Alternatively or additionally, the info packet may include the total quantity of packets (e.g., including sub-upgrade packets and interference packets) included in the matrix generated by the server, and the target terminal device may generate the dimension of the matrix (i.e., the root mean square of the total quantity) based on the total quantity. The target terminal device determines the dimensions of the generated matrix based on the quantity of sub-upgrade packets, which is similar to that described with respect to FIGS. 5A-5C, and the description is not repeated here.

In one embodiment, the target terminal device can restore the sequence of the sub-upgrade packets based on the reverse process of the server's translation process of the packets in the matrix.

FIG. 5D is a schematic diagram of an inverse process of a translation process of a packet according to an embodiment of the disclosure.

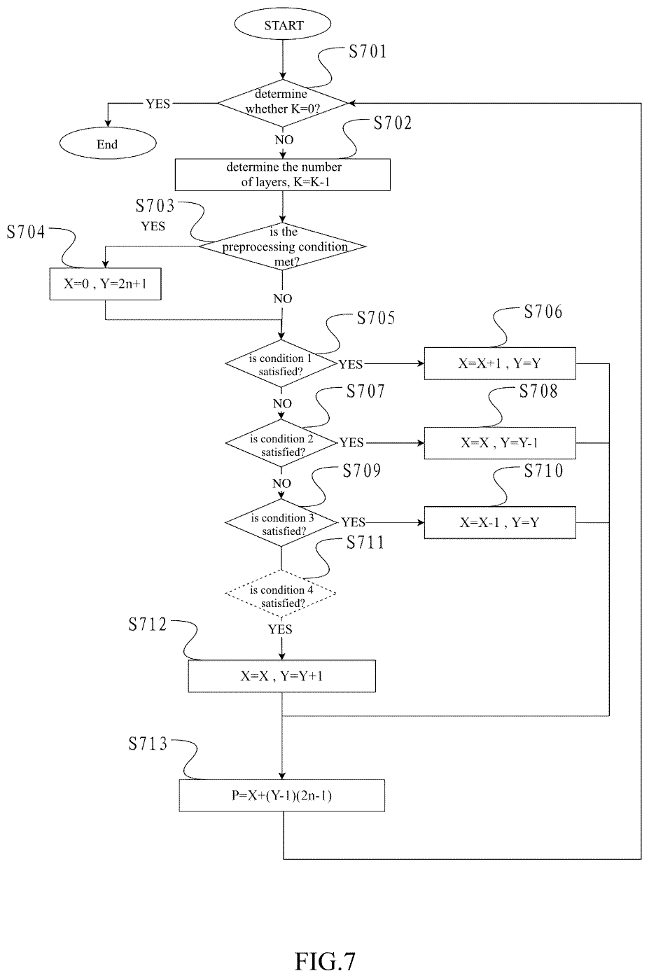

FIG. 7 is a flowchart of an inverse process of a translation process of a packet according to an embodiment of the disclosure.

With reference to FIGS. 5A-5D and FIG. 7, the reverse process of the translation process for each packet in the matrix is described. The following procedure for a packet in the matrix is performed.

In S701, it is determined whether the number of translation k is 0. The number of translation K=1, and the flow proceeds to S702.

In S702, the number of layers of the sub-upgrade packet with the original serial number P_new in the matrix can be determined according to the new serial number P_new. The method of calculating the number of layers is the same as that described in step S602 of FIG. 6, and the description is not repeated here. The new sequence number P_new=12 of the packet located in the center of FIG. 7A is taken as an example. The new serial number P_new=12 determines the coordinate (X, Y)=(2, 3) of the sub-upgrade packet in the matrix. The packet with P_new=12 has Layer=1 in the matrix. At the same time, subtract 1 from the value of k, and the value of k after subtraction is 0.

In the case of translation to the left, according to the number of layers of the packet in the matrix and the coordinates of the packet in the matrix, the way of translation of the packet in the matrix can be determined by the following conditions:

Preprocessing condition: the coordinates of the packet are X=n+1 and Y=n+1.

In S703, if the preprocessing condition is met, the flow proceeds to S704, and the coordinate of the packet is changed to: X=0, Y=2n+1, and the flow proceeds to S705; if the preprocessing condition is not satisfied, the flow proceeds directly to S705.

Condition 1: the coordinate of the packet is Y=Layer+n+1, and x<n+1+ layer; Or X=n+1−Layer and Y=n+1+Layer-1.

In S705, if the condition 1 is satisfied, the flow proceeds to S706, and the coordinate of the packet is changed as follows: add 1 to the X value, and the Y value remains unchanged; if condition 1 is not satisfied, the flow proceeds to S707.

In FIG. 5D, a packet satisfying condition 1 corresponds to a packet translated to the right, that is, a packet included in the dashed region 1.

Condition 2: the coordinate of the packet is X=n+1+Layer and Y<n+1−Layer.

In S707, if the condition 2 is satisfied, the flow proceeds to S708, and the coordinate of the packet is changed as follows: the value of X is unchanged, and the value of Y is reduced by 1; if the condition 2 is not satisfied, the flow proceeds to S709.

In FIG. 5D, the packet satisfying the condition 2 corresponds to the packet translated upward, that is, the packet included in the dashed region 4.

Condition 3: the coordinate of the packet is Y=n+1−Layer and n+1−Layer<X<n+1+Layer.

In S709, if the condition 3 is satisfied, the flow proceeds to S710, and the coordinate of the packet is changed as follows: the value of X is reduced by 1, and the value of Y remains unchanged; if condition 3 is not satisfied, the flow proceeds to S711.

In FIG. 5D, a packet satisfying the condition 3 corresponds to a packet translated to the left, that is, a packet included in the dashed region 3.

Condition 4: the coordinate of the packet is X=n+1−Layer, Y>n+1+Layer-1.

In S711, if the condition 4 is satisfied, the flow proceeds to S712, and the coordinate of the packet is changed as follows: the value of X is unchanged, and the value of Y is increased by 1.

In FIG. 5D, a packet satisfying the condition 4 corresponds to a packet translated downward, that is, a packet included in the dashed region 1.

It should be understood by those skilled in the art that in this embodiment, besides moving out of the matrix, there are four way of translations of the packet in the matrix, and under the condition that three of the four conditions are obtained, the way of translation of the packet can be determined by exclusion. FIG. 7 shows only three of the four conditions except the pretreatment conditions for brevity. The selection and execution sequence of Condition 1-Condition 3 in FIG. 7 are only exemplary.

As shown in FIG. 5D, the packet with new sequence number P_new=12 satisfies condition 1, and the way of translation of the packet with new sequence number P_new=12 is to move to the right, and the coordinate is changed to (3,3). The flow proceeds to S713, P=13.

The flow continues to S701, and the current K=0, and the flow ends.

The matrix can be restored from FIG. 5C to FIG. 5A by repeating the above-mentioned process of FIG. 7 for each packet in the matrix. In FIG. 5A, the sequence number of the sub-upgrade packet in the matrix is the same as the original sequence of the sub-upgrade packet. According to the number of the sub-upgrade packet in the recovered matrix and the quantity of the sub-upgrade packets, the sub-upgrade packets whose sequence is recovered can be obtained.

The above description is how the target terminal device moves the packets in the matrix when the number of translation is 1. Those skilled in the art can understand the process of restoring translation more times based on FIG. 5D and FIG. 7.

In one embodiment, the target terminal device can restore the sequence of the sub-upgrade packets by continuing to perform the translation process of the server to the packets in the matrix.

The translation process of the server to the packets in the matrix has been described above with reference to FIGS. 5A-5C and 6, and the description is not repeated here.

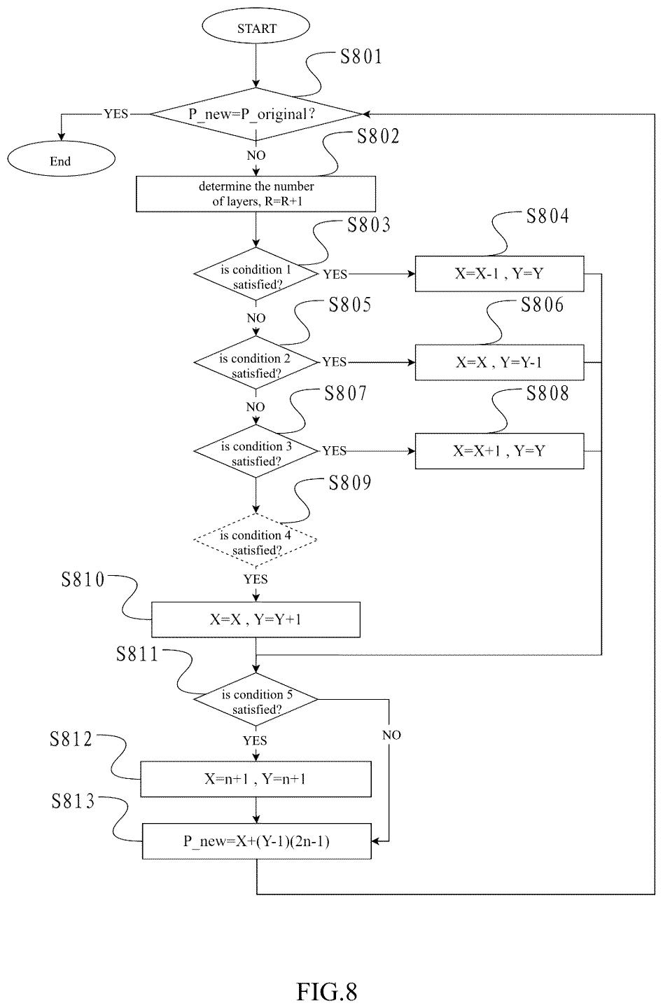

FIG. 8 is a flowchart for determining the number of translations performed by the server needs to be continued to recover the sequence of sub-upgrade packet according to an embodiment of the disclosure.

It is assumed that the packet with the initial sequence number of P_original is translated as shown in FIG. 6, and the new sequence number is P_new. The flow of FIG. 8 can be used to calculate how many times the translation performed by the server needs to be continued so as to make sequence of sub-upgrade packets to be restored.

At S801, it is determined whether P_original is equal to P_new. If not, the flow proceeds to S802.

In S802, the number of layers in the matrix of the sub-upgrade packets with the original serial number P_original can be determined according to the original serial number P_original. The determination method is similar to the process described above with reference to FIG. 6, and the description is not repeated. At the same time, add 1 to the R value, and the R value after adding 1 is equal to 1. S802-S813 are similar to S602-S613 in FIG. 6, and the description is not repeated.

The flow continues to S801, and the flow continues to be executed until P_new=P_original, and the flow ends. At the end, R indicates the number of times that the translation performed by the server needs to continue to be executed to restore the sequence of the sub-upgrade packet.

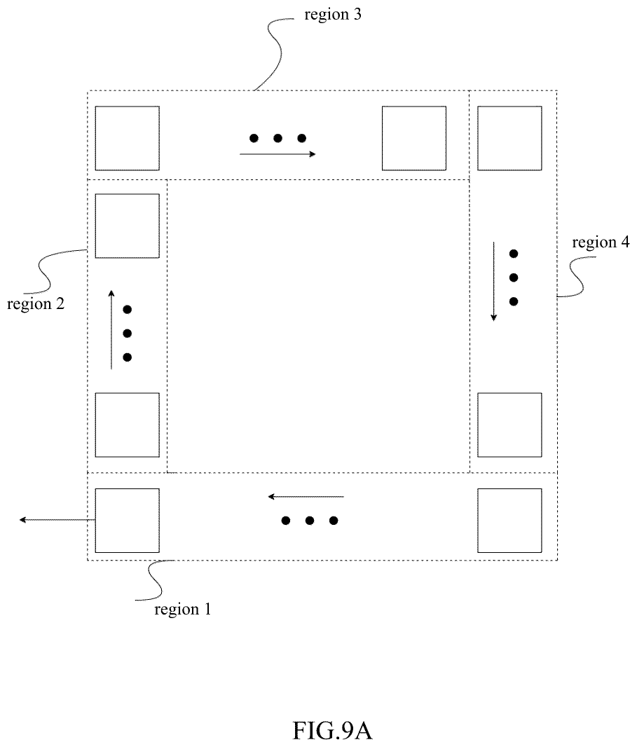

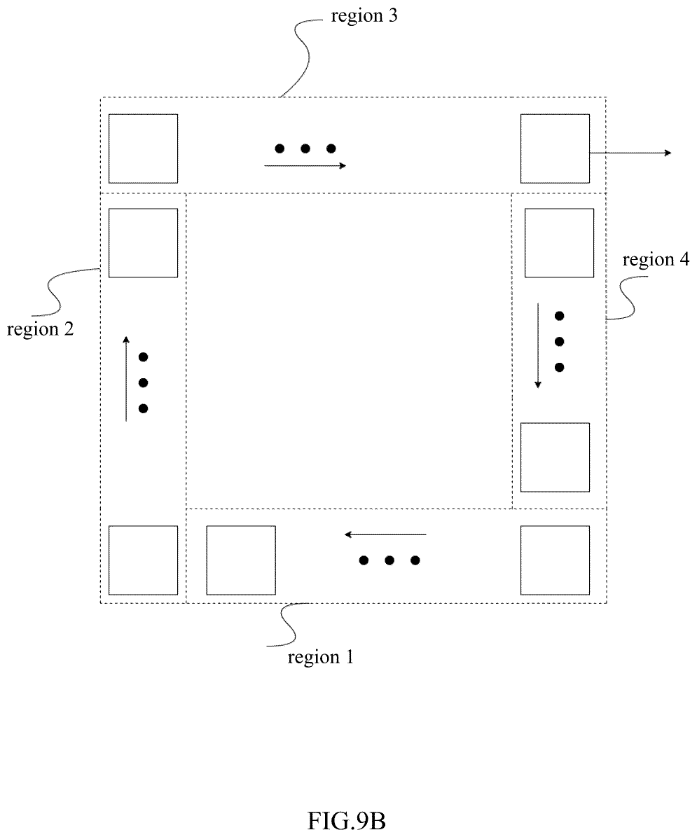

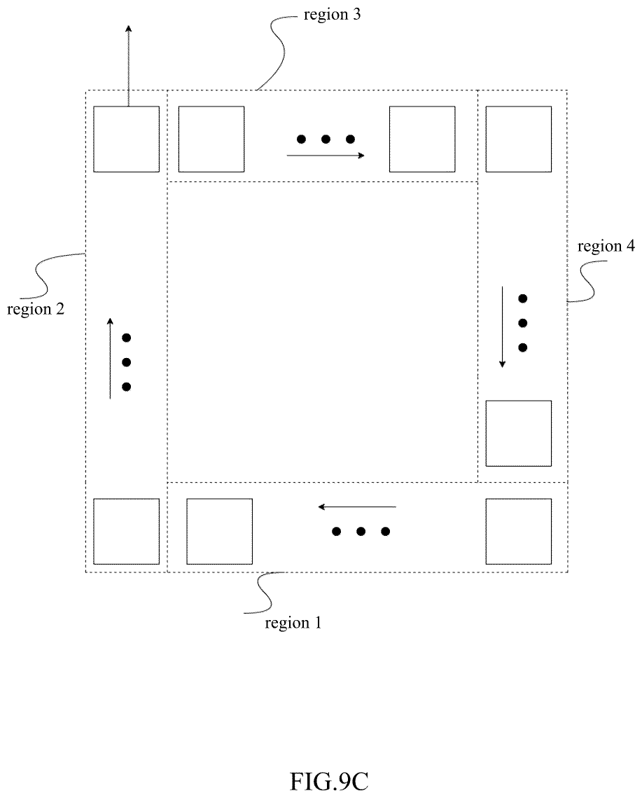

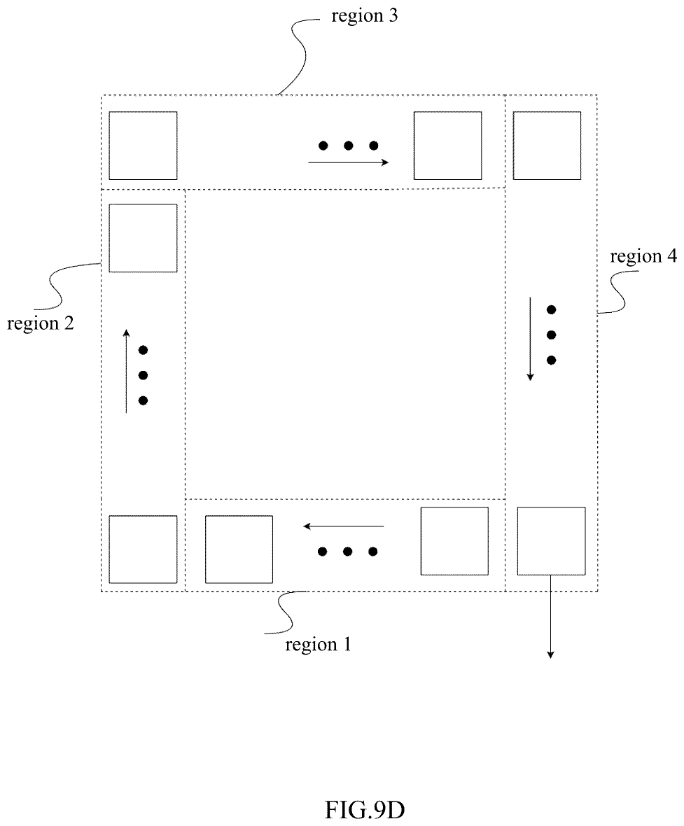

FIGS. 9A-9D are schematic diagrams of the manner in which a server translates packets in an odd dimension matrix according to different moving-out directions according to an embodiment of the disclosure.

In one embodiment, the number of layers Layer where the packet is located can be determined according to the sequence number P of each packet. Referring to the first layer and the second layer in FIG. 5A, when the moving direction is left and rotation is clockwise, the moving way of the packet in any layer in the matrix is as shown in FIG. 9A.

In region 1, the packet moves to the left, and the coordinates of the packet are changed to: X value minus 1, and Y value remains unchanged.

In region 1, the way of moving of the packet is upward, and the coordinates of the packet are changed to: the value of X is unchanged, and the value of Y is reduced by 1.

In region 3, the packet moves to the right, and the coordinate of the packet is changed to: x value plus 1, and y value remains unchanged.

In region 4, the way of moving of the packet is downward, and the coordinate of the packet is changed to: the value of X is unchanged, and the value of Y is increased by 1.

Based on the division of regions with different moving directions in the layer of FIG. 9A, the condition 1− the condition 5 for determining the moving direction of packets described with reference to FIG. 6 can be obtained.

With reference to FIG. 9B, the way of moving of packets in any layer in the matrix will be described when the moving direction is right or clockwise.

In region 1-region 4, the way of moving of packets is the same as that described with reference to FIG. 9A, and the description is not repeated here. Based on the division of areas with different moving directions in the layer of FIG. 9B, the condition that the server determines the moving direction of packets in the matrix when the moving direction is right and rotation is clockwise can be obtained, and the specific conditions are not described for brevity.

With reference to FIG. 9C, the way of moving of packets in any layer in the matrix will be described when the moving direction is up and clockwise.

In region 1-region 4, the way of moving of packets is the same as that described with reference to FIG. 9A, and the description is not repeated here. Based on the division of areas with different moving directions in the layer of FIG. 9C, the condition that the server determines the moving direction of packets in the matrix when the moving direction is upward and rotation is clockwise can be obtained, and the specific conditions are not described for brevity.

With reference to FIG. 9D, the way of moving of packets in any layer in the matrix will be described when the moving direction is downward and clockwise.

In region 1-region 4, the way of moving of packets is the same as that described with reference to FIG. 9A, and the description is not repeated here. Based on the division of areas with different moving directions in the layer of FIG. 9D, the condition that the server determines the moving direction of packets in the matrix when the moving direction is downward and rotation is clockwise can be obtained, and the specific conditions are not described for brevity.

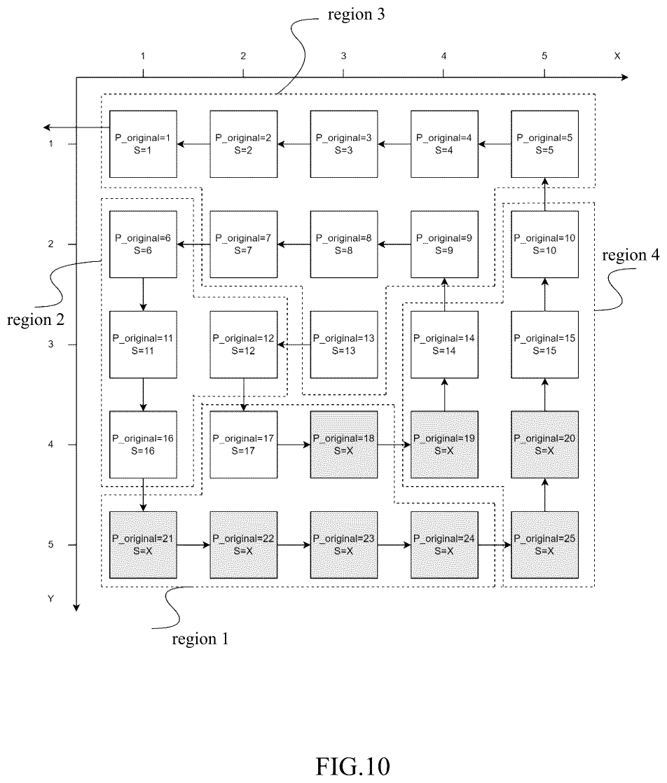

FIG. 10 is a schematic diagram of a server changing the sequence of sub-upgrade packets based on sequence identification indicating that the move-out direction is left and counterclockwise according to an embodiment of the disclosure.

In FIG. 10, the process of determining the layer where the packet is located is the same as that in FIG. 5A. The description will not be repeated. The process for the server to change the sequence of the sub-upgrade packets based on the sequence identification indicating that the move-out direction is left and counterclockwise is similar to the process for the server to change the sequence of the sub-upgrade packets based on the sequence identification indicating that the move-out direction is left and clockwise in FIG. 6. By adjusting Condition 1-Condition 5, the way of translation of packets in the matrix can be obtained.

When moving a packet in an odd dimension matrix, the packet moved out of the matrix is always put back at the center (n+1,n+1) of the odd-numbered matrix.

Referring to FIG. 9A-FIG. 10, the server can translate the packets in the matrix in a moving direction such as left, right, up and down and in rotation in clockwise or counterclockwise, and change the order of the sub-upgrade packets according to the sequence identification in the identification code. Accordingly, the target terminal can restore the sequence of the sub-upgrade packets through the reverse process of the process of the server translating the packets in the matrix according to the sequence identification in the identification code.

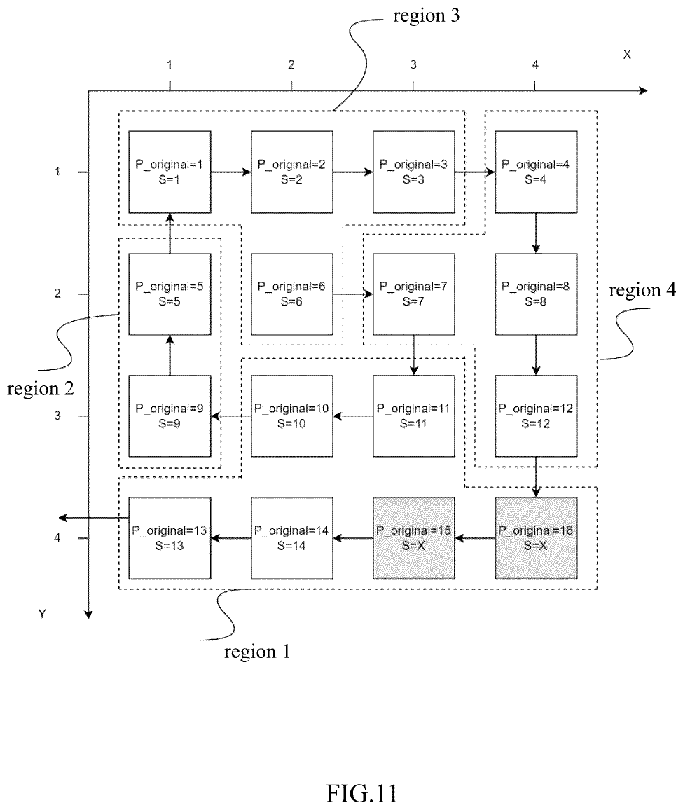

FIG. 11 is a schematic diagram of a server clock-wisely changes the sequence of sub-upgrade packets in an even dimensional matrix and the moving-out direction is left according to an embodiment of the disclosure.

Assume that there are N=14 sub-upgrade packets. According to equation (1), T=4, and the remainder of T over 2 is 0, so it can be determined to generate a matrix with even dimensions. When generating a matrix with even dimensions, the dimensions of the matrix are determined by the following equation:

$$n = roundup ( \sqrt{\frac{n}{4}} ) \qquad ( 5 )$$

According to equation (5), n=2, then the dimension of even matrix is 2n=4. That is, in the case of N=14 sub-upgrade packets, a 4-dimensional matrix as shown in FIG. 11 is generated. As shown in FIG. 11, 14 sub-upgrade packets with initial numbers of 1-14 are arranged in the matrix automatically from left to right. Each position of the matrix from left to right and from top to bottom has the original sequence number P_original. As shown in FIG. 11, 14 sub-upgrade packets cannot just fill the 4-dimensional matrix, and the matrix can be filled with interference packets (garbled packets, empty packets, or one or more of the reused 14 sub-upgrade packets) until the matrix is filled.

It is assumed that the sequence identification includes data with a preset number of bits indicating that the number of translation K is 1, the moving-out direction is left, and the rotation direction is clockwise. As shown in FIG. 11, the packet with coordinates (1,4) is moved to the left out of the matrix, and the packet rotates clockwise in the matrix. After the packet with coordinates (1, 4) is moved out of the matrix to the left, the packet moved out of the matrix is translated to the position (n,n) that will be vacant in the middle of FIG. 11.

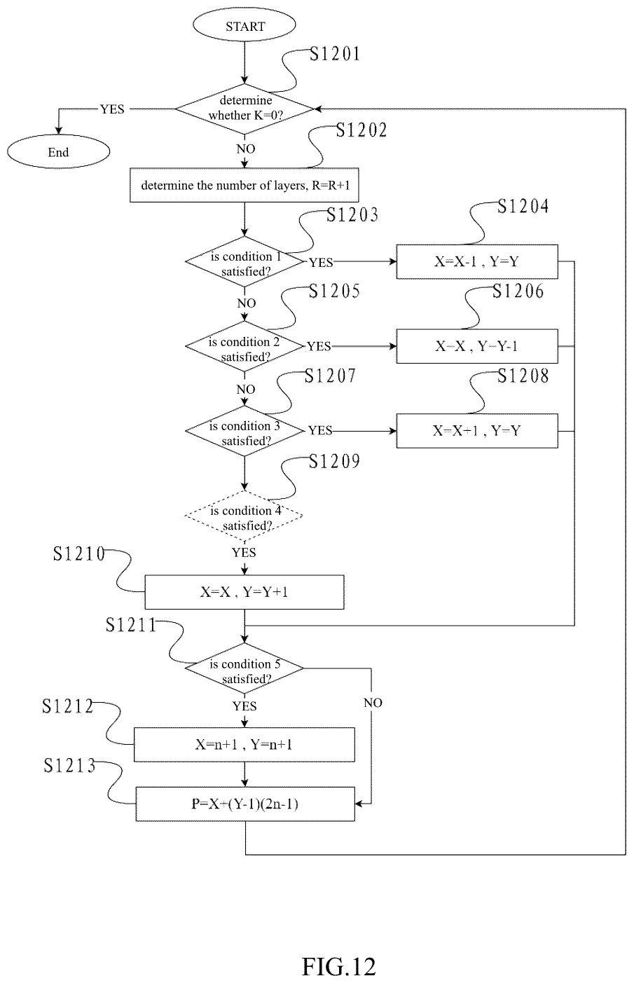

FIG. 12 is a flowchart for determining a way of translation of packets in an even dimensional matrix according to an embodiment of the disclosure.

With reference to FIG. 11 and FIG. 12, the process of determining the way of translation of the packet within the matrix will be described.

At S1201, it is determined that whether the number of translation K is 0. Number of translation K=1, and the flow proceeds to S1202.

At S1202, the number of layers of the sub-upgrade packet with the original serial number P_original in the matrix can be determined according to the original serial number P_original. The original sequence number P_original=13 of the packet in FIG. 11 is taken as an example.

$$P\_original / ( 2 n ) = ( Y - 1 ) …… X \qquad ( 6 )$$

Where (Y-1) is the quotient and x is the remainder. Equation (3) shows that the coordinate (x, y)=(2,2) of the sub-upgrade packet in the matrix is determined according to the original serial number P_original=6.

$$Layer = \vert max ( X - n - 0.5 , Y - n - 0.5 ) \vert + 0.5 \qquad ( 7 )$$

Where max (,) means taking the maximum value. According to equation (6), it can be calculated that the layer number of the packet with original sequence number P_original=6 in the matrix is Layer-0. At the same time, the value of K is reduced by 1, and the value of K after reduction by 1 is equal to 0.

In the case of translation to the left, according to the number of layers of the packet in the matrix and the coordinates of the packet in the matrix, the way of translation of the packet in the matrix can be determined by the following conditions:

Condition 1: the coordinate of the packet is Y=n+Layer.

At S1203, if condition 1 is satisfied, the flow proceeds to S1204, and the coordinate of the packet is changed as follows: the value of X is reduced by 1, Y and the value of Y is unchanged; if condition 1 is not satisfied, the flow proceeds to S1205.

In FIG. 11, a packet satisfying the condition 1 corresponds to a packet translated to the left, that is, a packet included in the dashed region 1.

Condition 2: the coordinate of the packet is X=n-Layer and Y<n-Layer.

At S1205, if the condition 2 is satisfied, the flow proceeds to S1206, and the coordinate of the packet is changed as follows: the value of X is unchanged, and the value of Y is reduced by 1; if the condition 2 is not satisfied, the flow proceeds to S1207.

In FIG. 11, the packet satisfying the condition 2 corresponds to the packet translated upward, that is, the packet included in the dashed region 1.

Condition 3: the coordinate of the packet is Y=n+1−Layer and X<n+Layer.

At S1207, if the condition 3 is satisfied, the flow proceeds to S1208, and the coordinate of the packet is changed as follows: the value of X is added by 1, and the value of Y is unchanged; if condition 3 is not satisfied, the flow proceeds to S1209.

In FIG. 5A, a packet satisfying the condition 3 corresponds to a packet translated to the right, that is, a packet included in the dashed region 3.

Condition 4: the coordinates of the packet are X=n+Layer and Y<n+Layer,

At S1209, if the condition 4 is satisfied, the flow proceeds to S1210, and the coordinate of the packet is changed as follows: the value of X is unchanged, and the value of Y is increased by 1.

In FIG. 11, the packet satisfying the condition 4 corresponds to the packet translated downward, that is, the packet included in the dashed region 4.

It should be understood by those skilled in the art that, in this embodiment, besides moving into the matrix, there are four way of translations of the packet within the matrix, and under the condition that three of the above four conditions are obtained, the way of translation of the packet can be determined by the exclusion method. The selection and execution sequence of Condition 1-Condition 4 in FIG. 12 are only exemplary.

Condition 5: The coordinate x of the moved packet=0.

At S1211, if the condition 5 is satisfied, the flow proceeds to S1212, and the coordinates of the packet are changed to: X=n, Y=n, and then the flow proceeds from S1212 to S1213. If condition 5 is not satisfied, the flow proceeds directly to S1213.

As shown in FIG. 11, the packet with original sequence number P_original=6 meets the condition 3 and is located in the dashed region 3 in the matrix, and the way of translation of the packet with original sequence number P_original=6 is to the right. The new sequence number of the translated packet with original sequence number P_original=6 is P_new=X+2n (Y-1)=7, as shown in FIG. 5C. The packet with original sequence number P_original=13 meets the condition 1 and is located in the dashed region 1 in the matrix, and the way of translation of the packet with original sequence number P_original=13 is left translation. The coordinate of the translated packet with original sequence number P_original=13 is (0,4), which mects condition 5. The coordinate of the packet with original sequence number P_original=13 is changed to (2,2), so the new sequence number of the translated packet with original sequence number P_original=13 is P_new=X+2n (Y-1)=6.

The flow continues to S1201, and the current K=0, and the flow ends.

By repeating the process of FIG. 12 for each packet in the matrix, the way of translation of all packets in the matrix can be obtained.

The above description is how the server translates the packets in the matrix when the number of translations is 1. Those skilled in the art can understand the process of translating more times based on FIGS. 11 and 12.

After the server has translated all the packets in the matrix for k times, P_new in the translated matrix is used as the number of the packets in the matrix and all the packets are transmitted to the target terminal device. In the process of transmitting, the sequence of sub-upgrade packets is disturbed and mixed with interference packets, which greatly increases the difficulty of cracking.

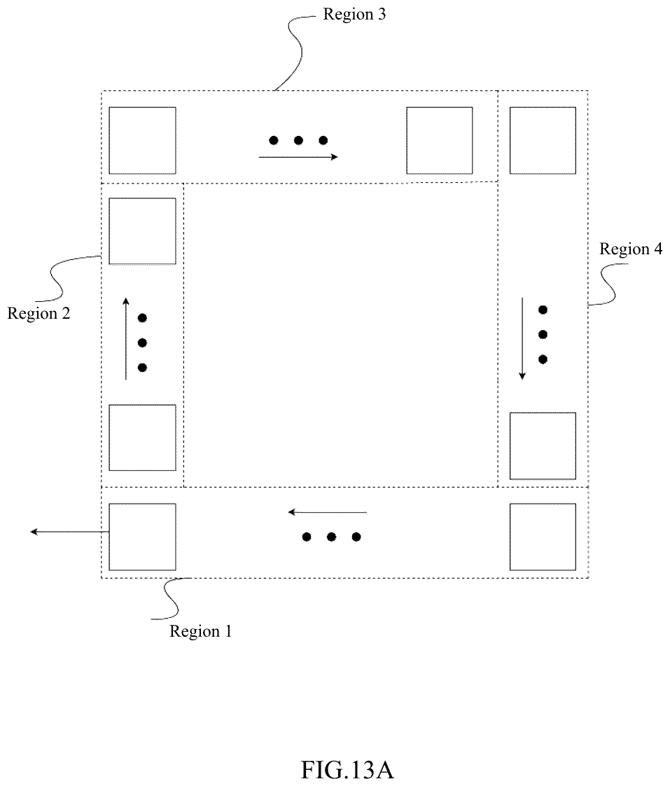

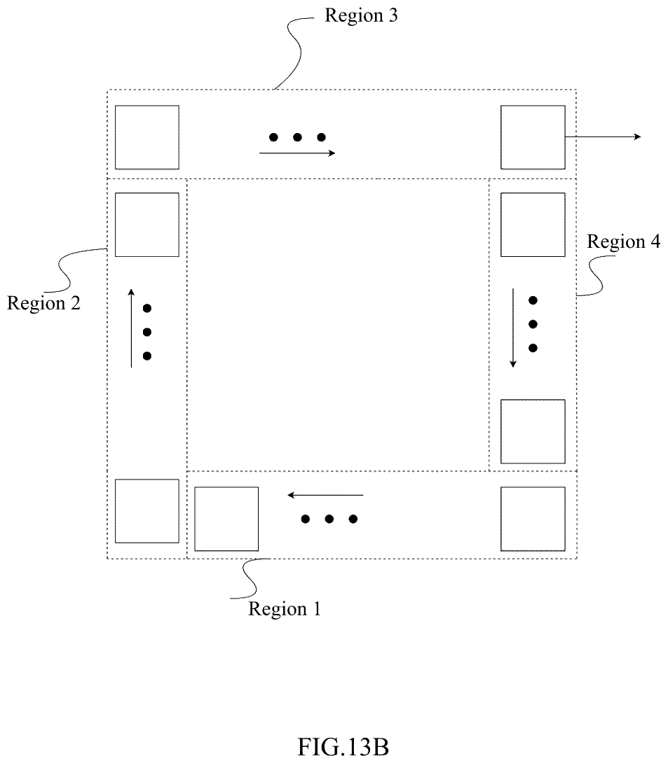

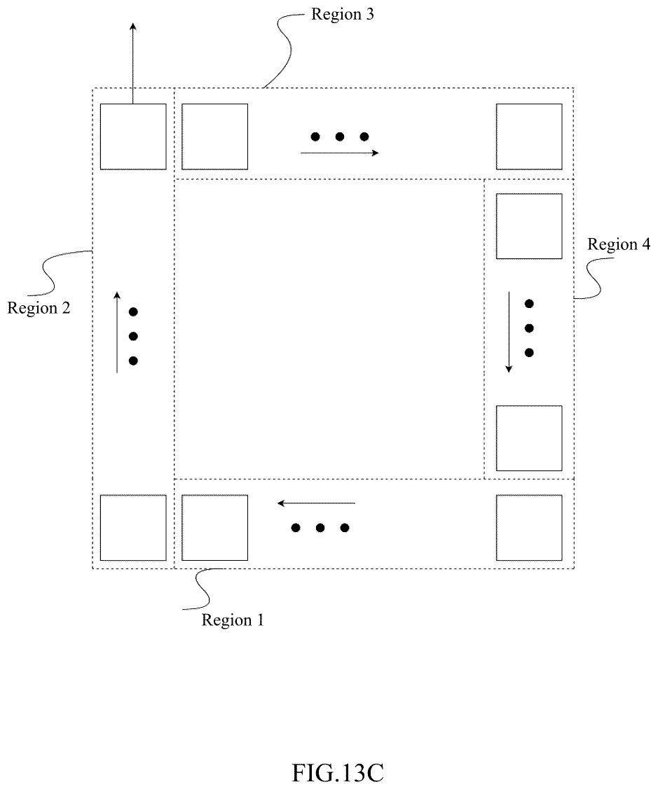

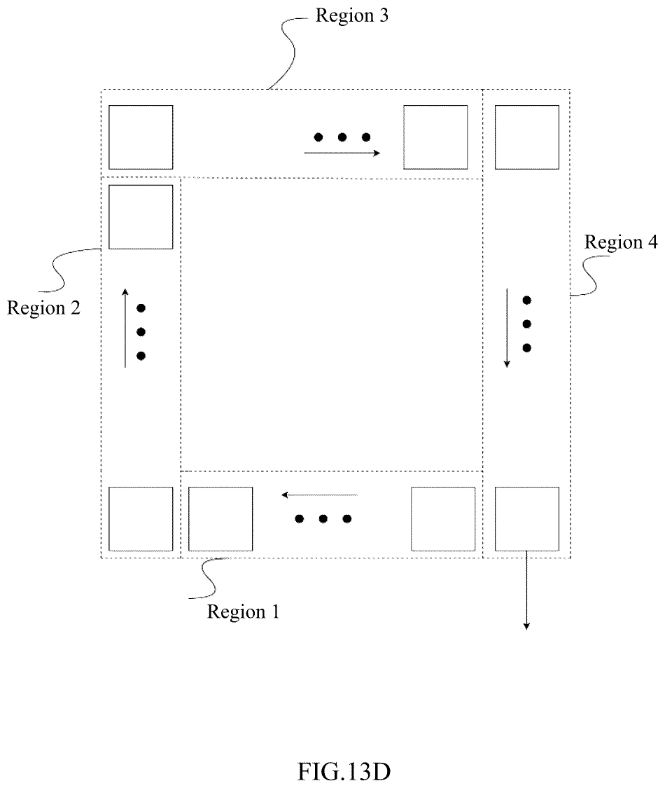

FIGS. 13A-13D are schematic diagrams describing the manner in which a server translates packets in an even-dimensional matrix according to different moving-out directions according to an embodiment of the disclosure.

In one embodiment, the Layer where the packet is located can be determined according to the sequence number p of each packet. Referring to the first layer and the second layer in FIG. 11, when the moving direction is left and rotation is clockwise, the way of moving of the packet in any layer in the matrix is as shown in FIG. 13A.

In region 1, the packet moves to the left, and the coordinate of the packet is changed to: X value minus 1, and Y value remains unchanged.

In region 1, the way of moving of the packet is upward, and the coordinates of the packet are changed to: x=the value of x and remains unchanged, and the value of y is reduced by 1.

In region 3, the packet moves to the right, and the coordinates of the packet are changed to: x value plus 1, and y value remains unchanged.

In region 4, the way of moving of the packet is downward, and the coordinates of the packet are changed to: the value of X is unchanged, and the value of Y is increased by 1.

Based on the division of areas with different moving directions in the layer of FIG. 13A, the condition 1—the condition 5 for determining the moving direction of packets described with reference to FIG. 12 can be obtained.

In FIG. 13A, the packet moved out of the matrix is put back at the coordinate (n,n).

With reference to FIG. 13B, the way of moving of packets in any layer in the matrix will be described when the moving direction is right or clockwise.

In region 1-region 4, the way of moving of the packet is the same as that described with reference to FIG. 13A, and the description is not repeated here. Based on the division of areas with different moving directions in the layer of FIG. 13B, the condition that the server determines the translation direction of packets in the matrix when the moving out direction is right and rotation is clockwise can be obtained, and the specific conditions are not described for brevity.

In FIG. 13B, the packets moved out of the matrix are put back at coordinates (n+1,n+1).

With reference to FIG. 13C, the way of moving of packets in any layer in the matrix will be described when the moving direction is upward and rotation is clockwise.

In region 1-region 4, the way of moving of the packet is the same as that described with reference to FIG. 13A, and the description is not repeated here. Based on the division of areas with different moving directions in the layer of FIG. 13C, the condition that the server determines the moving direction of packets in the matrix when the moving direction is upward and rotation is clockwise can be obtained, and the specific conditions are not described for brevity.

In FIG. 13C, the packet moved out of the matrix is put back at the coordinate (n+1,n).

With reference to FIG. 13D, the way of moving of packets in any layer in the matrix will be described when the moving direction is downward and rotation is clockwise.

In region 1-region 4, the way of moving of the packet is the same as that described with reference to FIG. 13A, and the description is not repeated here. Based on the division of areas with different moving directions in the layer of FIG. 13D, the condition that the server determines the moving direction of packets in the matrix when the moving direction is downward and rotation is clockwise can be obtained, and the specific conditions are not described for brevity.

In FIG. 13D, the packet moved out of the matrix is put back at the coordinate (n,n+1).

In addition, the sequence of sub-upgrade packets can be changed by translating the matrix in the matrix of even dimensions to realize counterclockwise rotation. For the sake of brevity, the detailed process will not be described.

In one embodiment, the target terminal device can restore the sequence of the sub-upgrade packets based on the reverse process of the server's translation process of the packets in the matrix. In one embodiment, the target terminal device can restore the sequence of the sub-upgrade packets by continuing to perform the translation process by the server to the packets in the matrix.

The embodiment in which the sequence of the sub-upgrade packets is changed in a rotating manner by translating the packets in the matrix has been described above. In addition to the above-described change/restoration of the sequence of sub-upgrade packets by translating the packets in the matrix of odd or even dimensions with a moving out direction of left, right, up and down, a rotation in clockwise and counterclockwise and a different number of translation, those skilled in the art who benefit from this disclosure can also move the packets in the matrix to change/restore the sequence of sub-upgrade packets without rotating or other translation methods. These are all within the contemplation of this disclosure.

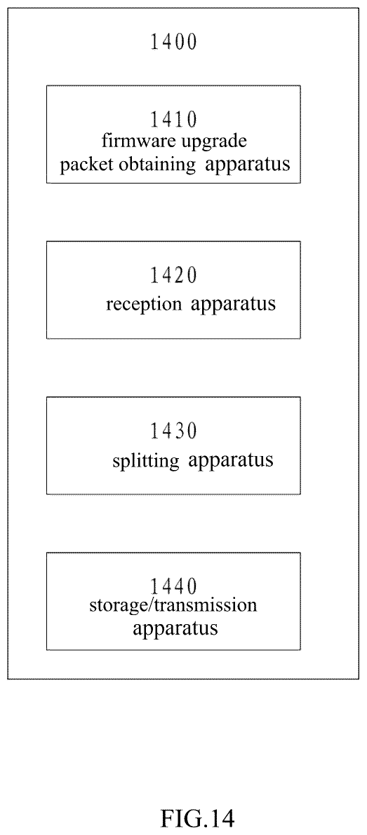

FIG. 14 is a firmware upgrade device for a server according to an embodiment of the disclosure.

As shown in FIG. 14, 1400 is a firmware upgrade device for a server.

The firmware upgrade device 1400 may include a firmware upgrade packet obtaining apparatus 1410 for obtaining a target firmware upgrade packet.

The firmware upgrading device 1400 may include a reception apparatus 1420 for receiving an identification code of a target terminal device.

The firmware upgrade device 1400 may include a splitting apparatus 1430 for splitting the target firmware upgrade packet into sub-upgrade packets based on the identification code of the target terminal device.

The firmware upgrade device 1400 may include a storage/transmission apparatus 1440 for storing and/or transmitting the sub-upgrade packets to the target terminal device.

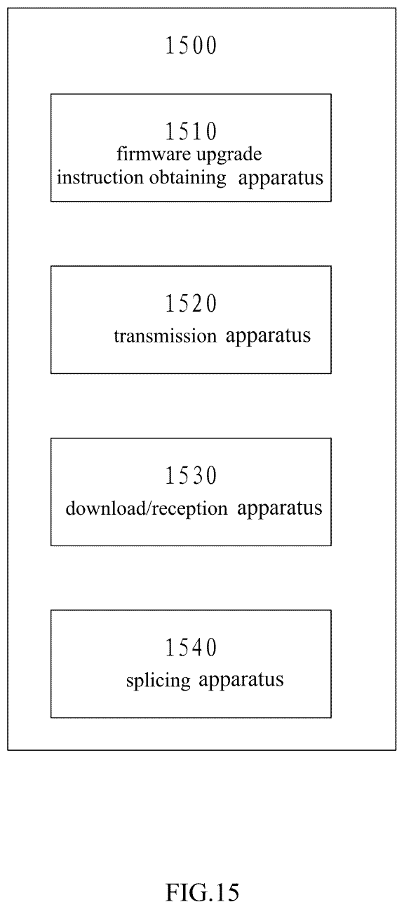

FIG. 15 is a firmware upgrade device for a terminal device according to an embodiment of the disclosure.

As shown in FIG. 15, 1500 is a firmware upgrade device for a target terminal device.

The firmware upgrade device 1500 may include a firmware upgrade instruction obtaining apparatus 1510 for obtaining a firmware upgrade instruction.

The firmware upgrading device 1500 may include a transmission apparatus 1520 for transmitting the identification code of the target terminal device.

The firmware upgrading device 1500 may include a download/reception apparatus 1530 for downloading/receiving the sub-upgrade packet.

The firmware upgrade device 1500 may include a splicing device 1540 for splicing the sub-upgrade packet into a target firmware upgrade packet based on the identification code of the target terminal device.

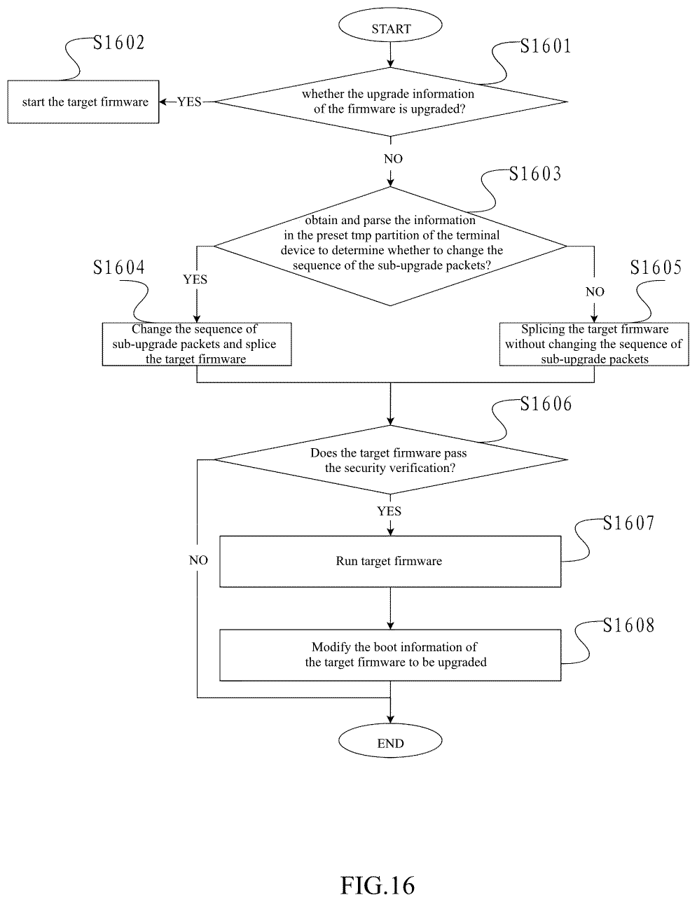

FIG. 16 is a flowchart for secure booting of a target terminal device according to an embodiment of the disclosure.

After the soft restart of the terminal device, the terminal device runs the security boot program.

At S1601, it is determined whether the upgrade information of the firmware is upgraded. If so, the flow proceeds to S1602 to start the target firmware.

If not, the flow proceeds to S1603, and the information in the tmp partition preset by the terminal device is obtained and parsed to determine whether to change the sequence of the sub-upgrade packet. In S1603-S1605, the process of determining whether to change the sequence of sub-upgrade packets and how to change the sequence of sub-upgrade packets is similar to the description in the corresponding part above, and the description is not repeated.

At S1606, it is determined whether the target firmware security verification has passed. Security verification can be perform on that target firmware according to the firmware upgrade key and/or integrity verification information contain in the firmware upgrade instruction. In some implementations, the integrity verification information is, for example, an md5 value, or other integrity verification information, and this embodiment is not limited to this. The info packet transmitted to the target terminal device may also include the firmware upgrade key and/or integrity verification information. Security verification of the target firmware is performed based on the firmware upgrade key and/or integrity verification information, and the security verification is passed under the condition that the firmware upgrade key carried by the info packet and transmitted to the terminal device are consistent with the firmware upgrade key in the firmware upgrade instruction and/or the integrity verification information of the terminal device is consistent with the integrity verification information in the firmware upgrade instruction. If the security verification fails, the process ends. If the security verification passes, the flow proceeds to S1607.

At S1607, the firmware upgrade packet can be run. In one embodiment, the firmware upgrade packet can be copied to the running address and jumped to the running address, that is, the upgraded target firmware can be run. In one embodiment, the firmware upgrade packet can be run directly from the corresponding partition in flash.

At S1607, the boot information of the target firmware can be modified to be upgraded.

Through the above-mentioned security boot process, on the basis of splitting the firmware upgrade packet and transmitting and downloading the sub-upgrade packet in sequence, the security of firmware upgrade can be further improved, the configuration operation of firmware integrity verification and safe startup can be realized, and the legitimacy of firmware can be guaranteed.

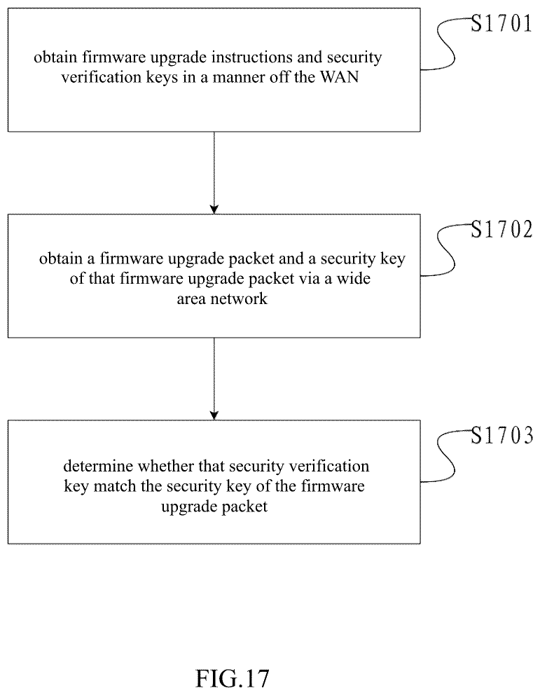

FIG. 17 is a flowchart for security verification with a combination of off-network and on-network for target terminal device according to an embodiment of the disclosure.

At S1701, the target terminal device can obtain the firmware upgrade instruction and the security verification key off the WAN (wide area network). The target terminal device can obtain the firmware upgrade instruction and the security verification key from the broadcast device off the WAN in the form of broadcast or point-to-point communication. The broadcast device off the WAN may be a handheld broadcast device, for example. In one embodiment, the target terminal device can obtain a download base address from a broadcast device that is out of the wide area network. The target terminal device can obtain the download address of the firmware upgrade packet based on the default modifiable address, download base address and identification code. Broadcasting device that is off the WAN can be realized by short-range wireless communication such as Bluetooth, Bluetooth LE, ZigBee, Radio Frequency Identification (RFID), UWB, 60 GHZ, Wi-Fi, WiMAX or wired communication such as USB. Because the broadcasting equipment is off the WAN, the security risks when transmitting through the WAN can be well avoided without using the WAN.

At S1702, a target terminal device can obtain a firmware upgrade packet and a security key of the firmware upgrade packet via a WAN.

At S1703, the target terminal device may determine whether the security verification key matches the security key of the firmware upgrade packet. For example, the target terminal device can determine whether the security verification key obtained off the WAN matches the firmware upgrade packet security key obtained via the WAN. If they match, it can be confirmed that the firmware upgrade packet is safe, otherwise report the risk information.

The process of obtaining the firmware upgrade packet by the target terminal device can be similar to the above-mentioned terminal device firmware upgrade process based on the identification code and the secure boot process for the target terminal device, and the description is not repeated here.

The text and drawings are provided as examples only to help understand the disclosure. They should not be construed as limiting the scope of the disclosure in any way. Although certain embodiments and examples have been provided, based on the disclosure herein, it is clear to those skilled in the art that changes can be made to the illustrated embodiments and examples without departing from the scope of this disclosure.

Although the disclosure has been described with exemplary embodiments, various changes and modifications can be suggested to those skilled in the art. . . . This disclosure is intended to cover such changes and modifications as fall within the scope of the appended claims.

Any description in the present invention should not be understood as implying that any particular element, step or function is an essential element that must be included within the scope of the claims. The scope of the patent subject matter is limited only by the claims.

1. A firmware upgrade method applied to a server, comprising:
obtaining a target firmware upgrade packet;
receiving an identification code of a target terminal device;
splitting the target firmware upgrade packet into sub-upgrade packets based on the identification code of the target terminal device;
storing the sub-upgrade packets and/or transmitting the sub-upgrade packets to the target terminal device.

2. The firmware upgrade method according to claim 1, wherein the method further comprises:
obtaining a size of the sub-upgrade packets through the identification code of the target terminal device,
determining a quantity of split sub-upgrade packets based on the size of the sub-upgrade packets.

3. The firmware upgrade method according to claim 1, wherein the method further comprises:
based on the identification code of the sub-upgrade packets and the default modifiable address, download address from which the target terminal device downloads the sub-upgrade packets is determined.

4. The firmware upgrade method according to claim 1, wherein the method further comprises:
obtaining the sequence identification of the sub-upgrade packets through the identification code of the target terminal device,
based on the sequence identification of the sub-upgrade packets, determining whether to change the sequence of the sub-upgrade packets,
in response to determining not to change that sequence of the sub-upgrade packets, the sub-upgrade packets are numbered according to the initial sequence of the sub-upgrade packets,
in response to determining to change the sequence of the sub-upgrade packets, the sequence of the sub-upgrade packets is changed, and the sub-upgrade packets are numbered according to the changed sequence of the sub-upgrade packets.

5. The firmware upgrade method according to claim 4, wherein each of the sub-upgrade packets comprises a sub-upgrade header, and the sub-upgrade header comprises a number of the sub-upgrade packet.

6. The firmware upgrade method according to claim 5, wherein the header of the sub-upgrade packet further comprises at least one of an identification code of the target terminal device and a quantity of sub-upgrade packets split by the target firmware upgrade packet.

7. The firmware upgrade method according to claim 4, wherein determining whether to change the sequence of the sub-upgrade packets based on the sequence identification of the sub-upgrade packets comprises:
identifying a numerical value indicated by the sequence identification,
determining whether to change the sequence of the sub-upgrade packets based on the numerical value indicated by the sequence identification.

8. The firmware upgrade method according to claim 7, wherein determining whether to change the sequence of sub-upgrade packets based on the numerical value indicated by the sequence identification comprises: determining whether to change the sequence of the sub-upgrade packet based on whether the numerical value indicated by the sequence identification is a first predetermined numerical value.

9. The firmware upgrade method according to claim 7, wherein determining whether to change the sequence of the sub-upgrade packets based on the numerical value indicated by the sequence identification comprises:
taking a remainder of the numerical value indicated by the sequence identification over a second predetermined numerical value, wherein the second predetermined numerical value is a natural number greater than or equal to 2,
based on the remainder, determining whether to change the sequence of the sub-upgrade packet.

10. The firmware upgrade method according to claim 9, wherein the second predetermined value is 2, wherein determining whether to change the sequence of the sub-upgrade packets based on the numerical value indicated by the sequence identification comprises determining whether to change the sequence of the sub-upgrade packets based on the parity of the numerical value indicated by the sequence identification.

11. The firmware upgrade method according to claim 4, wherein changing the sequence of the sub-upgrade packets based on the sequence identification comprises:
identifying the numerical value indicated by the sequence identification,
changing the sequence of the sub-upgrade packets based on the numerical value indicated by the sequence identification.

12. The firmware upgrade method according to claim 11, wherein the sequence identification comprises data with a predetermined number of bits, and identifying the numerical value indicated by the sequence identification comprises identifying the numerical value indicated by the data,
wherein, changing the sequence of the sub-upgrade packets comprises:
dividing the sub-upgrade packets into sub-upgrade packet groups, each sub-upgrade packet group comprises a specific quantity of sub-upgrade packets adjacent in the initial sequence, wherein the specific quantity is the maximum numerical value that data with a predetermined number of bits can indicate plus 1,
exchanging the sequence of two sub-upgrade packets in each sub-upgrade packet group whose initial sequence differs by the numerical value indicated by the data.

13. The firmware upgrade method according to claim 4, wherein changing the sequence of the sub-upgrade packets comprises:
dividing the sub-upgrade packets into sub-upgrade packet groups, each sub-upgrade packet group comprises a specific quantity of sub-upgrade packets adjacent in the initial sequence, wherein the specific quantity is determined in advance at the server,
exchanging the sequence of two sub-upgrade packets in each sub-upgrade packet group whose initial sequence differs by numerical value less than the specific quantity.

14. The firmware upgrade method according to claim 4, further comprising generating a matrix according to the quantity of sub-upgrade packets,
the sub-upgrade packets are arranged in a matrix,
wherein, changing the sequence of the sub-upgrade packets comprises translating the sub-upgrade packets in the matrix according to the sequence identification.

15. (canceled)

16. (canceled)

17. (canceled)

18. (canceled)

19. (canceled)

20. A firmware upgrade method applied to a terminal device, comprising:
obtaining a firmware upgrade instruction;
transmitting an identification code of the target terminal device;
download sub-upgrade packets from the server;
based on the identification code of the target terminal device, splicing the sub-upgrade packet into a target firmware upgrade packet.

21. The firmware upgrade method according to claim 20, wherein the method further comprises downloading a header of the firmware upgrade packet from the server, and performing follows by security boot program:
in response to downloading all sub-upgrade packets and the firmware upgrade header to the terminal device, determining whether to change the sequence of downloaded sub-upgrade packets based on the sequence identification in the identification code of the terminal device;
performing a security or integrity verification on the downloaded sub-upgrade packets;
in response to the downloaded sub-upgrade packet passing the security or integrity verification, running the target firmware spliced by the sub-upgrade packets.

22. The firmware upgrade method according to claim 21, wherein obtaining the firmware upgrade instruction comprises obtaining the firmware upgrade instruction and the security verification key off the WAN;
wherein, downloading sub-upgrade packets from the server comprise obtaining the firmware upgrade packet and a security key of the firmware upgrade packet via WWN;
performing the security verification on the downloaded sub-upgrade packets includes determining whether the security verification key matches the security key of the firmware upgrade packet.

23. (canceled)

24. (canceled)

25. (canceled)

26. (canceled)

27. (canceled)

28. A security verification method for a target terminal device, comprising:
obtaining a firmware upgrade instruction and a security verification key off WAN;
obtaining a firmware upgrade packet and a security key of that firmware upgrade packet via WAN;
determine whether that security verification key match the security key of the firmware upgrade packet.

29. The security verification method according to claim 28, wherein obtaining the firmware upgrade packet via the WAN comprises downloading the sub-upgrade packets from the server via the WAN, wherein the method further comprises:
transmitting the identification code of the target terminal device;
splicing the sub-upgrade packets into a target firmware upgrade packet based on the identification code of the target terminal device.

30. The security verification method according to claim 29, wherein the method further comprises downloading the header of the firmware upgrade packet from the server, and performing:
in response to all sub-upgrade packets and firmware upgrade headers being downloaded to the target terminal device, determining whether to change the sequence of downloaded sub-upgrade packets based on the sequence identification in the identification code of the target terminal device;
performing a security or integrity verification on the downloaded sub-upgrade packets;
in response to the downloaded sub-upgrade packet passing the security or integrity verification, running the target firmware spliced by the sub-upgrade packets.
